(19) United States
(12) Patent Application Publication
(10) Pub. No.: US 2024/0211892 A1
(43) Pub. Date: Jun. 27, 2024

(54) DIGITAL SELF-REGISTRATION SYSTEM

(71) Applicant: Experian Health, Inc., Franklin, TN (US)

(72) Inventors: Ali Saffari, Diamond Bar, CA (US); Spiro E. Kalapodis, Valencia, CA (US); Jason M. Considine, Frisco, TX (US); Jennifer Rosenquist, Nolensville, TN (US)

(21) Appl. No.: 18/527,027

(22) Filed: Dec. 1, 2023

Related U.S. Application Data
(63) Continuation of application No. 16/738,836, filed on Jan. 9, 2020.
(60) Provisional application No. 62/791,339, filed on Jan. 11, 2019.

(51) Int. Cl. G06Q 10/1093; G01C 21/34; G06Q 10/02; G06Q 20/40; H04L 67/55; H04W 4/14; H04W 68/00

(52) U.S. Cl. CPC G06Q 10/1095; G01C 21/343; G06Q 10/02; G06Q 20/4014; H04L 67/55; H04W 4/14; H04W 68/005

(57) ABSTRACT

Aspects include a system that provides an end to end, digital self-registration experience to significantly limit and/or eliminate the time a user must spend in a registrar or waiting area checking in and filling out paperwork prior to a scheduled appointment, while also increasing accuracy of the user information obtained. For example, once an appointment has been scheduled for the user, the system may generate and transmit a push notification, such as a text message, to the user's device. The text message may include a selectable link directing the user to an application that guides the user seamlessly through a self-registration process. The self-registration process includes, among other steps, identity verification, payer verification, provision of demographic information, appointment confirmation, and post-confirmation steps (e.g., form completion, reminders, and day of appointment instructions and directions). Additionally, the system may monitor and facilitate an authorization process associated with the appointment.

### CROSS-REFERENCE TO RELATED APPLICATIONS

This application claims the benefit of U.S. patent application Ser. No. 16/738,836, filed Jan. 9, 2020, titled “DIGITAL SELF-REGISTRATION SYSTEM,” and U.S. Provisional Application No. 62/791,339, filed Jan. 11, 2019, titled “Digital Self-Registration System,” which are incorporated herein by reference in their entirety.

### BACKGROUND

Registration processes that are required before services are rendered, including check-ins for various service appointments, are often cumbersome and inconvenient. For example, a person may be required to arrive early and physically check-in to provide information and fill out paperwork, where the paperwork may be unnecessarily repetitive and voluminous. The person may then have to wait long periods of time before the services are rendered. Additionally, the person may have to pay for the services during check-in, which may mean a longer check-in process and waiting period as other people are trying to process their payments as well.

In a healthcare service context, the process of patient registration often occurs within a medical facility, such as a hospital, urgent care, or other similar clinic, when a patient schedules an appointment in order to receive medical care or have a procedure performed. Registration may occur at a diagnostic phase of the procedure process, such as when the patient is getting an MRI, a CT, an X-ray or other similar diagnostic test, or during a post-diagnostic but pre-procedure consult. To provide an example scenario, a patient may have been involved in an ice-related accident that caused the patient to slip and land on their hand wrong. The patient may go to an urgent care and indicate their hand hurts, and the urgent care physician will X-ray the hand. Upon looking at the X-ray, the urgent care physician may determine that the patient will need to be referred to a specialist. The specialist may perform a consult and determine that the patient needs hand surgery. An appointment for the patient's hand surgery may be scheduled and the process of patient registration may be initiated. For registration, various types of information may be needed from the patient at the time of scheduling so that it may be processed pre-surgery (e.g., insurance information to enable authorization of the surgery), as well as on the day of the surgery.

Traditionally, registration involves many steps that must be manually performed by the patient, often in uncomfortable environments. For example, the patient must fill out paperwork including medical history information, demographic information, identification information, and insurance information, as well as consent and information release forms. Often the patient is provided this paperwork to fill out on a clipboard as the patient waits in the waiting room. This is problematic because a majority of patients do not like waiting rooms or filling out redundant paperwork multiple times over. Also, patients may feel rushed and worried because they see the physicians moving in and out of each of the rooms. The patients may be concerned that if they do not fill out the paperwork quickly enough, they may lose their spot in line and have to wait longer before they see the physician.

In addition to patient discomfort, healthcare providers are concerned about the quality of the information that they are receiving from patients under this conventional registration system. Patients often make mistakes about some of the information they are providing through paperwork. Patients may not be frequent customers of healthcare and unfamiliar with the healthcare system in general causing them to provide incorrect insurance information, among other information. For example, a patient may accidentally provide information from a pharmacy loyalty card instead of their insurance card. Obtaining objective data is important in making sure the healthcare providers are billing the right person and have the accurate information to do so.

Moreover, insurance companies who are paying on behalf of the patients for the medical procedures are disadvantaged by the inaccurate information often received under this traditional registration process. Due to inaccuracies, insurance companies are increasingly having to push healthcare providers and patients to provide additional information to authorize procedures. The additional time and effort it takes for insurance companies to get this information needed for authorization results in confusion for patients that do not understand the healthcare system and a delay in care, which ultimately further reduces quality and lowers patient satisfaction.

### SUMMARY

The present disclosure provides systems and methods for optimizing registration processes. Aspects include a self-registration system that provides an end to end, digital self-registration experience to significantly limit and/or eliminate the time a user must spend in a registrar or waiting area checking in and filling out paperwork prior to a scheduled appointment.

An example self-registration system may generate a push notification informing the user of a self-registration process for an upcoming service appointment, and transmit the push notification to a client device associated with the user. The push notification may provide access to an application for initiation of the self-registration process. For example, the system may include a text-to-mobile service, where the client device may receive the push notification in a form of a text message comprising a link. Upon selection of the link, the user may be directed to the application, which loads onto any device, such as a smartphone, tablet, laptop, or desktop computing device, and guides the user seamlessly through the self-registration process (e.g., by running through a number of pages). The self-registration process includes, among other steps, identity verification, payer verification, provision of demographic information, appointment confirmation, and post-confirmation steps (e.g., form completion, reminders, and day of appointment instructions). Additionally, the self-registration system monitors and facilitates an authorization process associated with the appointment.

In one example embodiment, the self-registration system may be provided as a service to health care providers, where the self-registration system may be communicatively coupled to various systems of the healthcare providers to facilitate communication of information between the systems. In other example embodiments, the self-registration may be provided as a service to other service providers that require users to register and/or a check-in for scheduled appointments, such as aesthetic services and vehicle maintenance services, among other examples.

This summary is provided to introduce a selection of concepts; it is not intended to identify all features or limit the scope of the claimed subject matter.

### BRIEF DESCRIPTION OF THE DRAWINGS

The accompanying drawings, which are incorporated in and constitute a part of this disclosure, illustrate various aspects and examples of the present invention. In the drawings:

FIG. 1 is a block diagram of an example environment in which a system of the present disclosure can be implemented;

FIGS. 2A-2Z illustrate example push notifications and application user interfaces associated with an initial phase of a self-registration process;

FIGS. 3A-3C illustrate example push notifications and application user interfaces associated with an authorization clearance phase of a self-registration process;

FIGS. 4A-4C illustrate example push notifications and application user interfaces associated with a form completion phase of a self-registration process;

FIGS. 5A-5F illustrate example push notifications and application user interfaces associated with a post confirmation phase of a self-registration process;

FIGS. 6A-6E represent a flow chart showing general stages involved in an example method for self-registration;

FIG. 7 is a flow chart showing general stages involved in an example method for monitoring and facilitating authorization;

FIG. 8 illustrates an example method, performed by a self-registration system, for providing a digital self-registration experience; and

FIG. 9 is a block diagram illustrating physical components of an example computing device with which aspects may be practiced.

### DETAILED DESCRIPTION

The following detailed description refers to the accompanying drawings. Wherever possible, the same reference numbers are used in the drawings and the following description to refer to the same or similar elements. While aspects of the present disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the present disclosure, but instead, the proper scope of the present disclosure is defined by the appended claims. Examples may take the form of a hardware implementation, or an entirely software implementation, or an implementation combining software and hardware aspects. The following detailed description is, therefore, not to be taken in a limiting sense.

The present disclosure provides systems and methods for optimizing registration processes through a self-registration system operating in a digital environment. Although examples given herein primarily involve healthcare providers and patients, it will be recognized that the present disclosure is applicable to other types of entities that provide services to users involving registration and/or check-in for scheduled appointments. Improvements to registration not only improve the processes and systems themselves and the accuracy of information collected, but improve access to and satisfaction with the provided services.

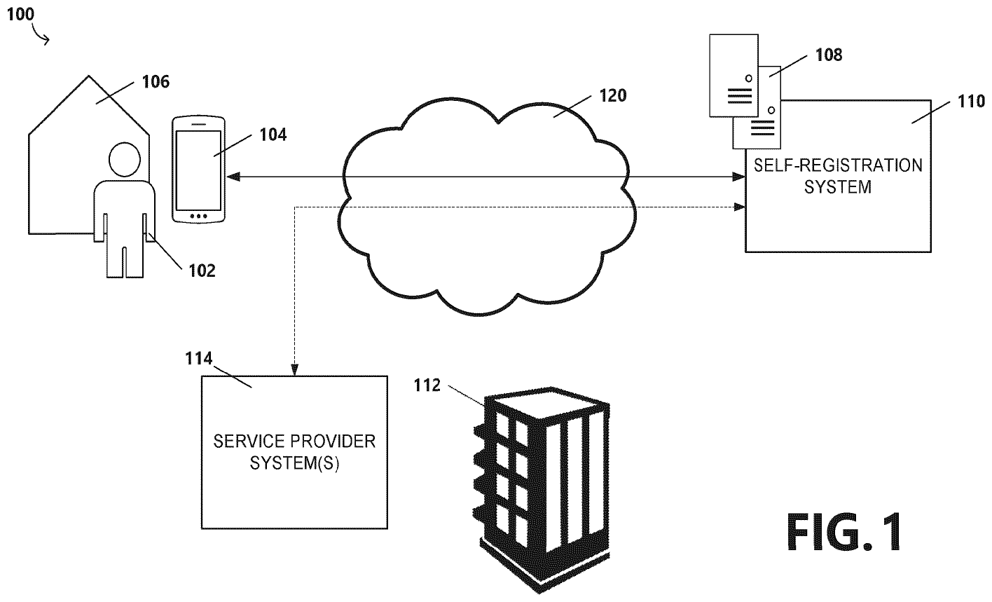

FIG. 1 is a block diagram of an example environment 100 in which a self-registration system 110 of the present disclosure can be implemented. The self-registration system 110, hereinafter referred to as system 110, may host a text-to-mobile service that provides, among other things, an end to end, digital self-registration experience to a user 102 on behalf of a service provider, for example. The system 110 may include one or more processing servers 108, of which, at least one may be operable to execute the text-to-mobile service hosted by the system 110, including a self-registration application, discussed herein.

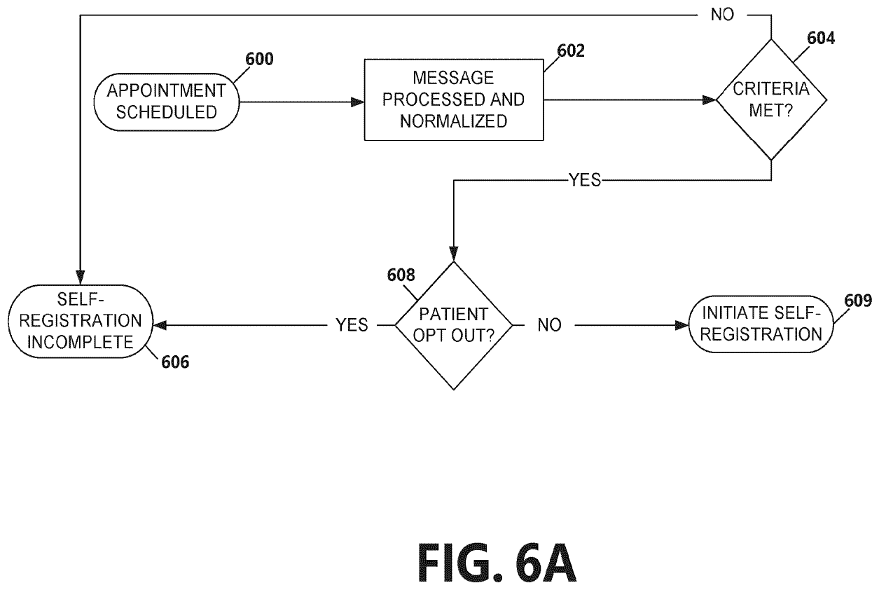

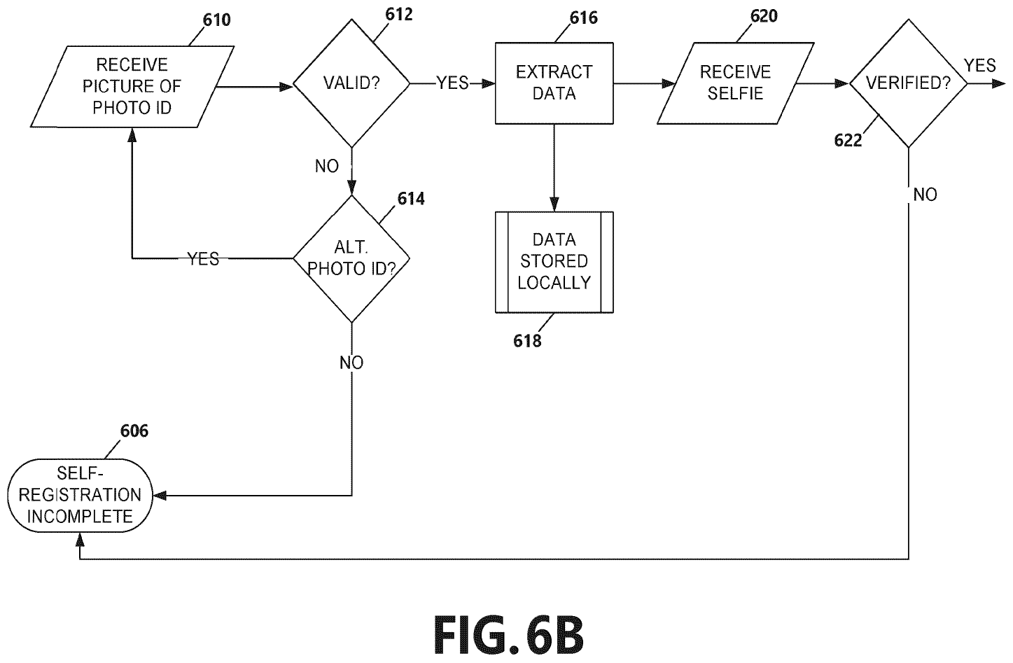

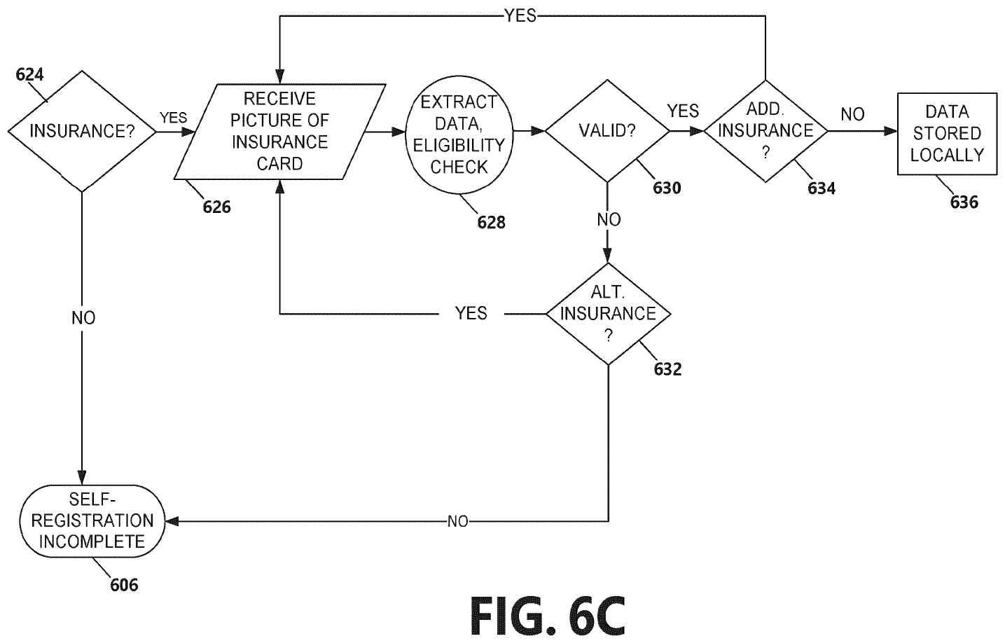

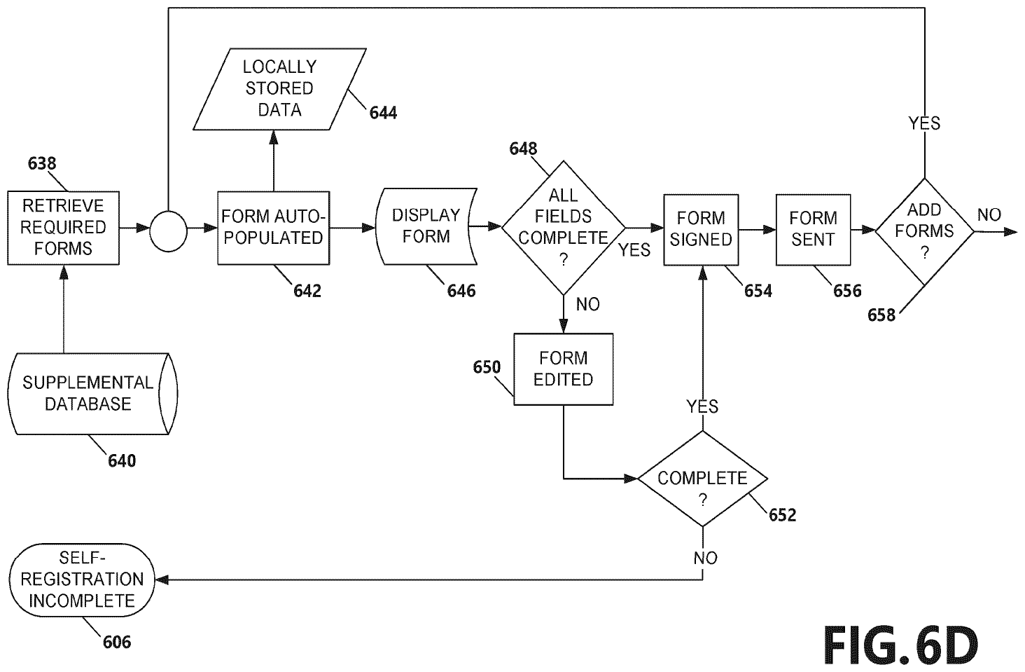

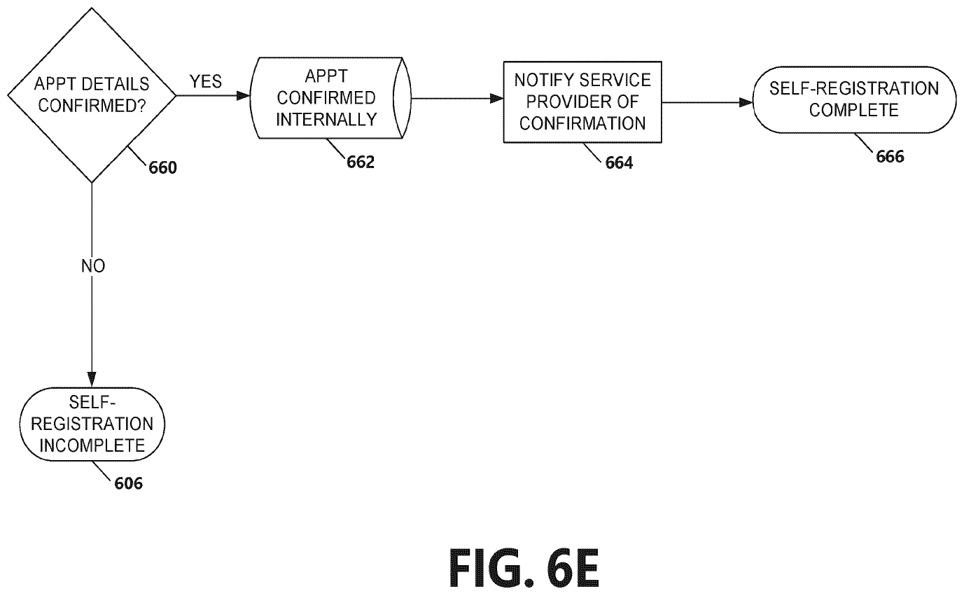

In one embodiment, the text-to-mobile service may interoperate with the self-registration application to enable the user 102 to self-register for a service appointment over a network 120 using the device 104. This allows the user 102 to complete a self-registration process for the service appointment, described in detail in FIGS. 6A-6E, from the comfort of their own home 106 or office, among other locations, rather than a location of the service provider, such as building 112, on the day of the service appointment. According to an example aspect, the service appointment may be initiated or scheduled by the user 102 using a scheduling service provided by the system 110. For example, the device 104 may execute a thin version of the application (e.g., a web application accessible via a web browser) or a thick version of the application (e.g., a locally installed application). The application may provide a user interface for display on the device 104 that enables the user 102 to schedule the service appointment. According to another example aspect, the service appointment which the user 102 may use the application to complete the self-registration process for may be initiated or scheduled by a service provider. For example, a first service provider may be a primary care physician and may use the scheduling service to initiate or schedule a service appointment with a specialist for the user 104. The device 104 may include a desktop computer, a laptop computer, a tablet computer, a smart phone, or wearable computing device, among other similar devices. A communication interface may facilitate communication between the system 110 and the device 104 over one or more networks, such as the network 120. Additionally, the system 110 may be communicatively coupled to one or more service provider systems 114 to facilitate communication of information between the systems over the network 120.

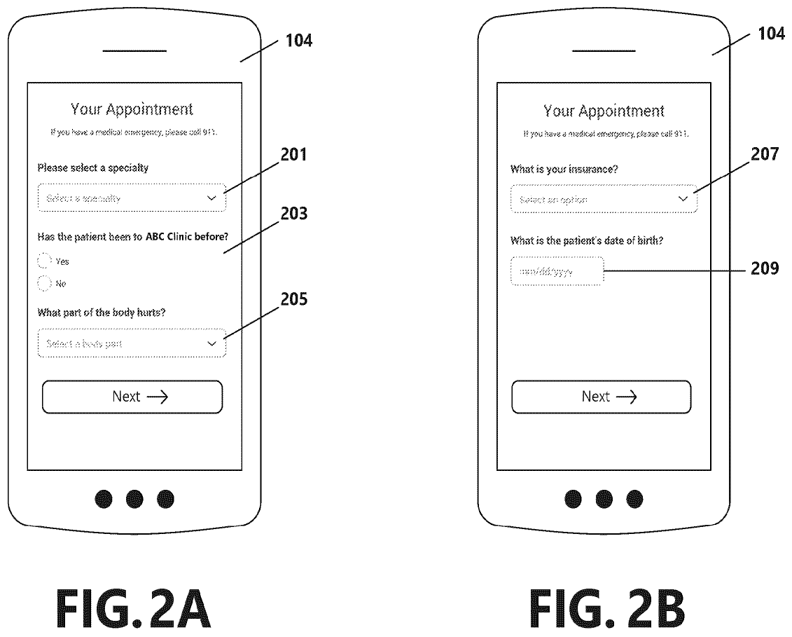

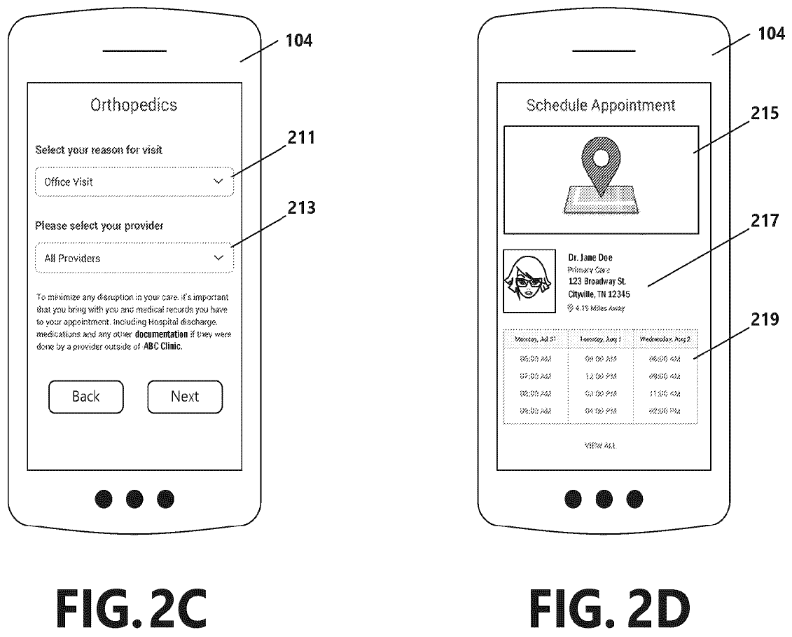

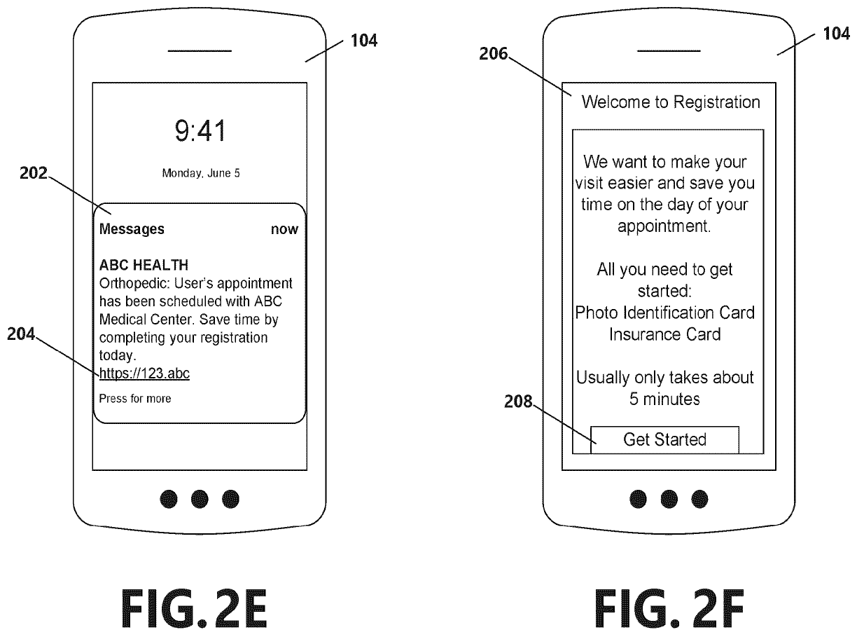

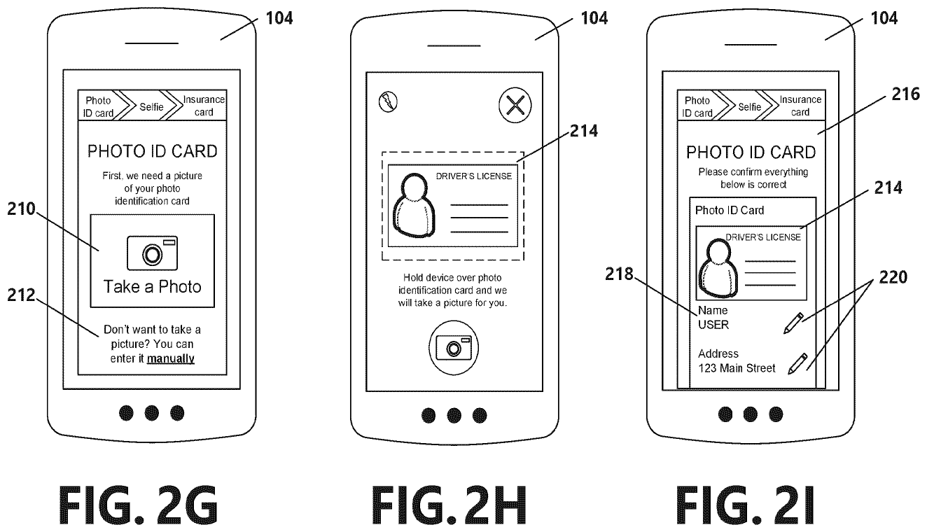

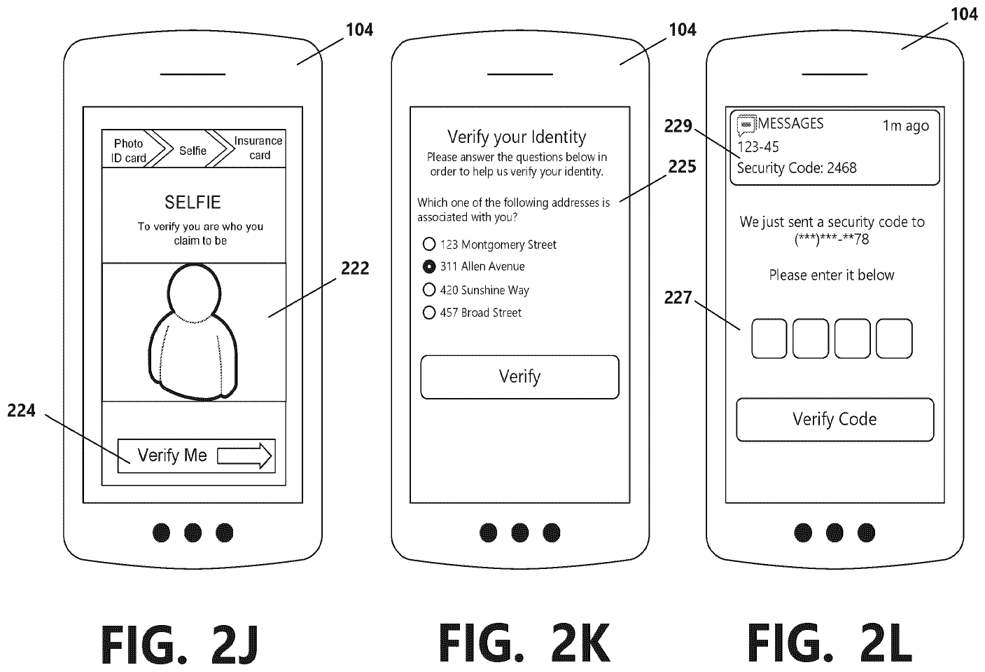

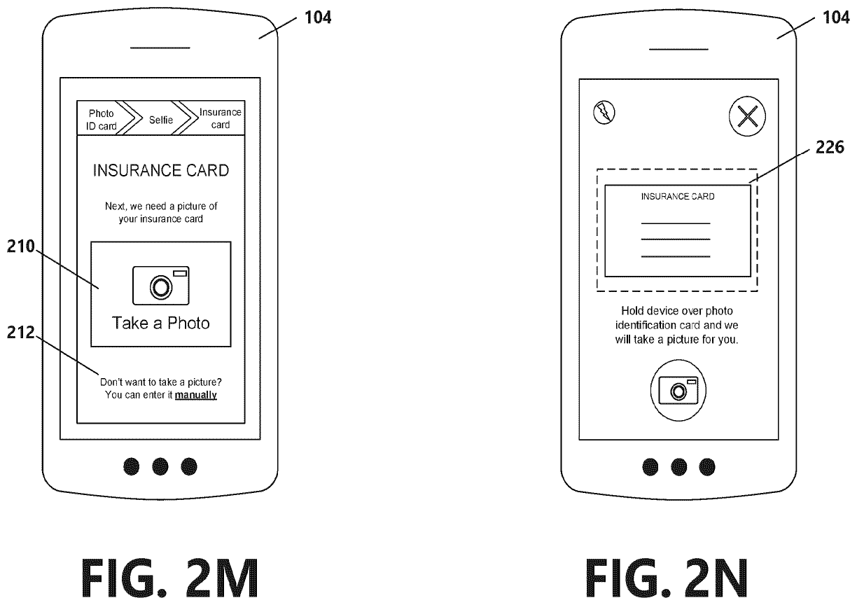

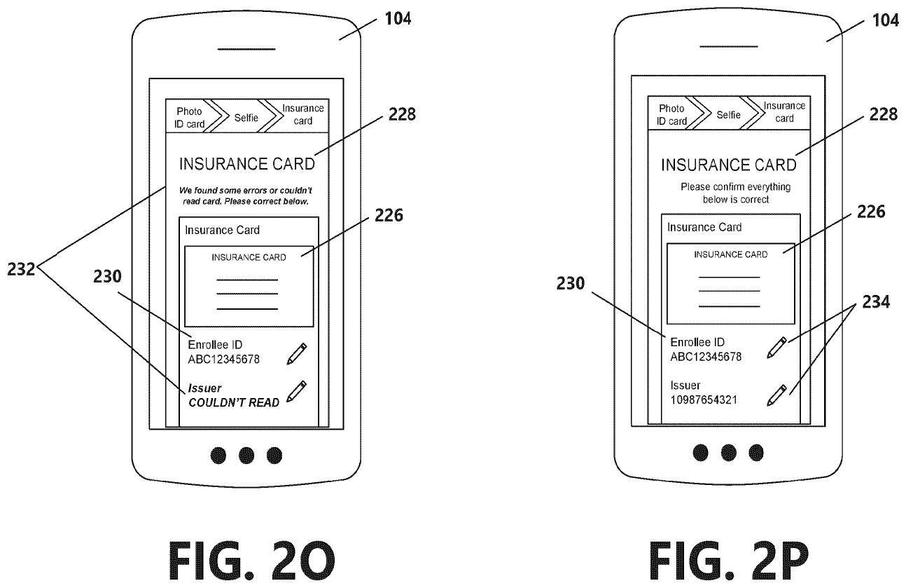

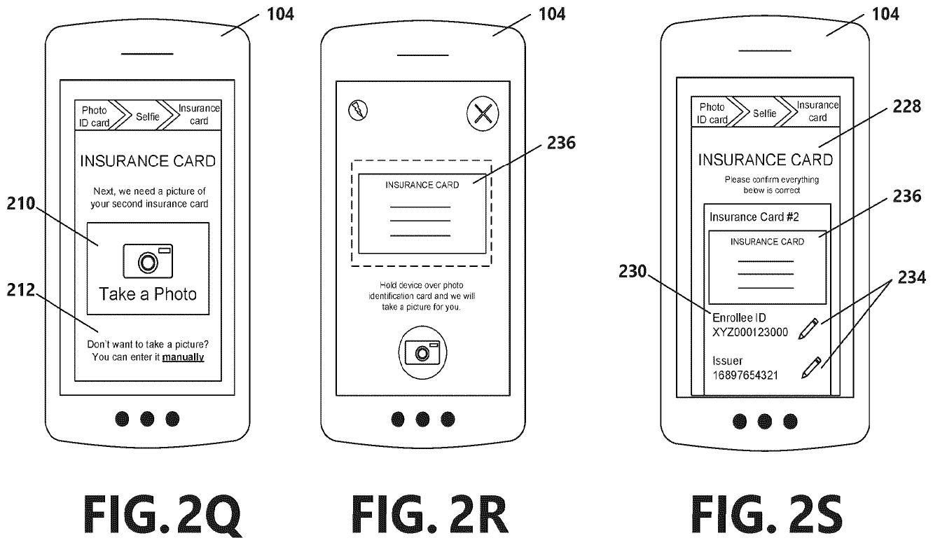

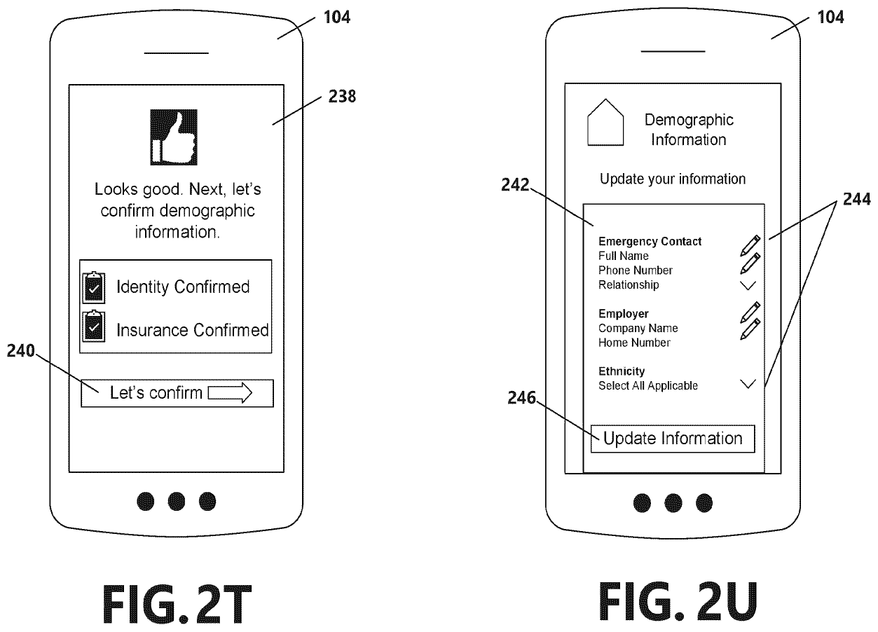

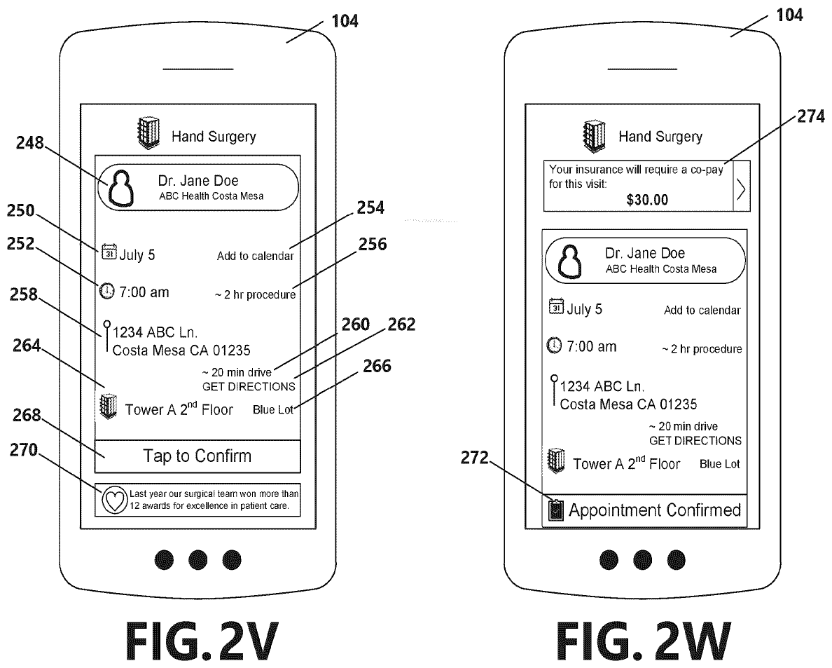

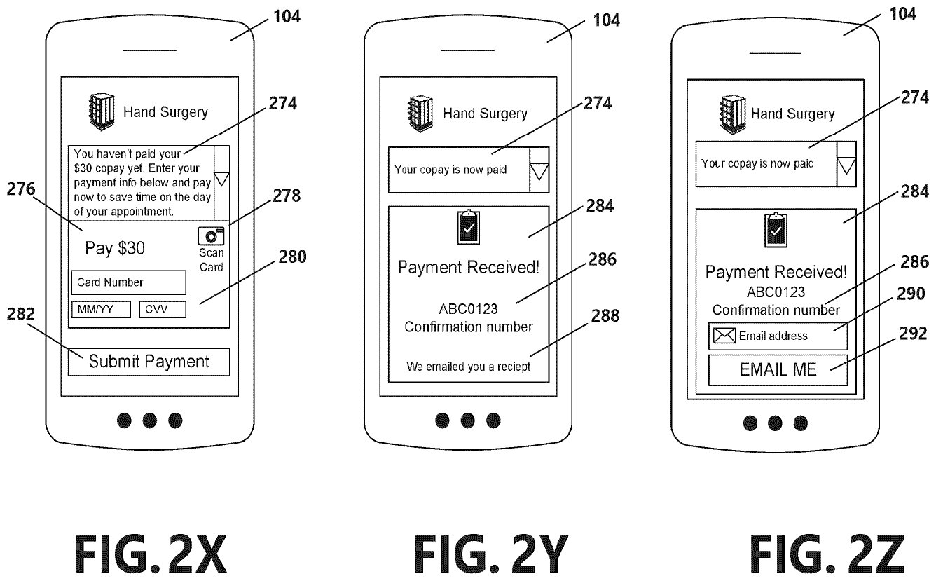

FIGS. 2A-2Z illustrate example push notifications and application user interfaces associated with an initial phase of a self-registration process.

To reintroduce an example scenario previously provided, a patient may have been involved in an ice-related accident that caused the patient to slip and land on their hand wrong. The patient may go to an urgent care and indicate their hand hurts, and the urgent care physician will X-ray the hand. Upon looking at the X-ray, the urgent care physician may determine that the patient will need to be referred to a specialist. The specialist may perform a consult and determine that patient needs hand surgery. An appointment for the patient's hand surgery may be scheduled and the self-registration process may be initiated.

In some examples, once the consultation with the specialist is over, the patient may leave the exam room and stop at a receptionist area to schedule the appointment. As one example, the receptionist may schedule the appointment for the patient as an event within a health information system (HIS) associated with the urgent care facility (i.e., healthcare provider). The HIS may be included in one of the service provider systems 114 communicatively coupled to the system 110. As another example, the receptionist can automatically schedule the appointment on behalf of the patient using the scheduling service of the system 110. While scheduling the appointment, the receptionist may ask for the patient's mobile device number and obtain the patient's consent to participate in the self-registration so that the patient may be enabled to self-register for the upcoming appointment via a text-to-mobile service on the patient's mobile device (e.g., a smartphone). Alternatively, the patient may consent to participation in the self-registration digitally by clicking on a link provided through the healthcare provider's website, for example, and providing necessary information. In other examples, the patient may use the scheduling service of the system 110 to initiate or schedule the appointment themselves.

FIGS. 2A-2D show example application user interfaces displayed on the patient's device 104 that can be used to initiate scheduling of a service appointment. For example, the patient (i.e., user 102) may launch a thin version or a thick version of the application on the device 104 to initiate or schedule the appointment. The application may provide access to one or more services of the system, including the scheduling service. The application may be configured to provide one or more user interfaces associated with the scheduling service for display on the device 104 via which scheduling information can be input for scheduling the service appointment. The one or more user interfaces may include various fields via which various scheduling information can be input for scheduling the service appointment. For example and as shown in FIG. 2A, a field 201 may be provided for enabling thepatient to select a specialty associated with the service appointment for which the patient wants to schedule. The field 201 may include a drop down option, which when selected, provides a display of various selectable specialties from which the patient may select. Another field 203 may be provided for enabling the patient to specify whether he/she is a previous or current patient of the service provider, and another field 205 may be provided via which the patient may select a part of the body for which he/she is seeking treatment. As shown in FIG. 2B, additional fields 207,209 may be displayed in the user interface for enabling the patient to enter additional information, such as the patient's benefits provider, also referred to herein as the payer (field 207), and the patient's date of birth (field 209).

As illustrated in FIG. 2C, the patient may be prompted to enter or select additional or alternative scheduling information. For example, a field 211 may be provided for allowing the patient to select a reason for the service appointment. Another field 213 may be provided for enabling the patient to select a specific service provider or physician.

Based on the patient's selections, the user interface may be updated to display a listing of one or more service providers. The user interface may further include instructions that may provide for a more efficient and/or optimized service appointment. As one example, the instructions may inform the patient about what to bring with them to the appointment, such as medical records.

As illustrated in FIG. 2D, the user interface may include information about the one or more service providers, such as a map 215 showing the location of the service provider, contact information 217 of the service provider, and scheduling availability 219 of the service provider. According to an example, available dates/times included in the scheduling availability 219 may be selectable, wherein the service appointment may be scheduled for the patient responsive to a selection of an available date/time. As should be appreciated, other and/or additional fields may be provided by the application for enabling the patient to schedule a service appointment. In some examples, in association with or after scheduling the service appointment, the patient may be provided with various options for registering for and/or consenting to participate in self-registration. For example, the user interface may include an option that enables the patient to select to receive a text message and register on his/her mobile device (i.e., device 104) with the system 110. As another example, the user interface may include an option that enables the patient to select to receive a link and register on a personal computer (i.e., device 104) including or connected to a web camera. As another example, the user interface may include an option to register in person at the time of the service appointment.

Continuing with the example scenario described above and as shown in FIG. 2E, the patient who had been scheduled for the hand surgery and has consented to participate in the patient self-registration may receive a push notification in a form of a text message 202 on their device 104, such as their smartphone. In other examples, the patient may receive the text message 202 on a tablet, laptop, desktop computing device, or wearable computing device, among other similar devices. The text message 202 may include a selectable link 204. In response to the patient selecting the link 204, an application associated with the system 110 may be executed and a user interface of the application provided for display on the patient's device 104 to guide the patient through the self-registration process. The application may be a web application or a native application, for example. As shown in FIG. 2F, the application user interface may display an introductory page 206 that welcomes the patient to the self-registration process and informs them of what materials they will need to get started. The introductory take to ease their mind. The self-registration process may initiate upon the user's selection of the “Get Started” control 208 at the bottom of the introductory page 206.

First, as shown in FIG. 2G, the application may prompt the patient to provide a picture of a photo identification card by providing a first, automatic take photo option 210 that utilizes a camera on the device 104. Alternatively, the application may provide the patient a second, manual option 212 to enter information from the photo identification card. Example photo identification cards may include a driver's license, a passport, a student identification card, or other similar card that comprises a photograph of a person and identifying information for the person.

If the first, automatic take photo option 210 is selected, a camera application may be executed on the device 104 allowing the camera to capture an image 214 of the photo identification card (e.g., a driver's license), as shown in FIG. 2H. The image 214 may be scanned and optical character recognition implemented to extract textual information from the driver's license, such as a name, address, and driver's license number, among other information. In some embodiments, the tools to perform the scanning and optical character recognition may be built into the system 110. In other embodiments, a third party service may perform the scanning and optical character recognition, and provide the extracted information to the system 110.

As shown in FIG. 21, the extracted information may be input directly into corresponding fields 218 of an identification information confirmation page 216, and displayed on the application user interface along with the image 214 of the driver's license or other similar photo identification card. In some embodiments, as the identification information is extracted, a verification process may be run in the background to ensure that the identification information is valid and/or accurate. For example, an address extracted from the driver's license may be verified through credit header information. The patient may also be prompted to confirm that the information input into each of the fields 218 is correct, where the patient can edit any of the fields 218 to correct errors by selecting an associated edit control 220. For example, if the patient recently got married and/or divorced and has a different last name or if the patient has changed addresses. If the patient does edit any of the fields 218, the verification process may be re-run in the background to ensure that the edited identification information is valid and/or accurate.

Second, the application may prompt the patient to provide information that can be used to verify that the person self-registering is actually the patient. According to one aspect and as shown in FIG. 2J, the patient may be prompted to provide a self-portrait photograph 222 of themselves (e.g., a selfie) utilizing the camera on the device 104. For example, the camera application may be executed on the device 104 allowing the camera to capture the self-portrait photograph 222. Upon selection of the “Verify Me” control 224, the system 110 may use the self-portrait photograph 222 to verify the person self-registering is actually the patient themselves and the person whose photo identification was provided. This step is crucial in a digital environment where anyone can register for healthcare services. Using facial recognition management tools, the patient may be verified by comparing the self-portrait photograph 222 with the photograph of the person within the photo identification card to determine whether or not they match. To enhance reliability of the recognition (e.g., to prevent someone from just using a photo of the patient to take a “selfie” of), the patient may be asked to perform a specific activity when taking the self-portrait photograph 222, such as to blink or shake his head. In some embodiments, the tools to perform the facial recognition may be built into the system 110. In other embodiments, a third party service may perform the facial recognition and provide the verification to the system 110.

According to another aspect and as illustrated in FIG. 2K, the patient may be prompted to provide answers to one or more security questions as an identity verification method. For example, one or more security questions 225 may be presented that prompt the patient to enter or select one or more answers/responses that include identity elements that can be verified against one or more data sources. That is, the one or more security questions 225 may be based on information known about the patient by the application, by a third party service, or by an identity verification service coupled to the system 110. Non-limiting examples of identity elements that may be used for verification include demographic information, answers to questions previously provided by the patient, credit profile data (permitted for use by the patient), public information (e.g., property records), etc. The one or more security questions 225 may be in the form of fill-in-the-blank, multiple choice, true or false, etc. The system 110 may verify the patient's identity by comparing the patient's answer(s) to the one or more security questions 225 against the known information/identity elements about the patient, or by using an identity verification service coupled to the system 110 or a third party system to verify the identity elements and provide a verification determination to the system 110. In an example aspect, the verification determination may include information indicative of whether the patient's responses match the identity elements, and may further include information indicative of a level of the matches.

According to another aspect and as illustrated in FIG. 2L, the application may be configured to send an authentication code 229 to the patient via a known phone number (e.g., text message) or email address, which the patient may be prompted to enter in a designated field 227 in the user interface. The system 110 may verify the patient's identity by comparing the authentication code entered in the designated field 227 against the authentication code 229 sent to the patient. According to another example aspect, the application may be configured to use one or more biometric methods to verify the patient's identity. For example, the device 104 may include a biometric scanner, such as a fingerprint scanner, iris scanner, face scanner, etc., which scans a biometric feature of the patient and compares the scanned feature against stored data (e.g., stored on the device 104). If the scan matches the data on file, the biometric scanner may provide verification to the system 110. As should be appreciated, other identity verification methods are possible and are within the scope of the present disclosure.

Third, as shown in FIG. 2M, the application may prompt the patient to provide a picture of a card associated with a payer by providing the first, automatic take photo option 210 that utilizes the camera on the device 104. Alternatively, the application may provide the second, manual option 212 to enter information from the card. Example cards associated with the payer may include an insurance card, a health savings account card, and a credit card, among others.

If the first, automatic take photo option 210 is selected, a camera application may be executed on the device 104 allowing the camera to capture an image 226 of the card (e.g., an insurance card), as shown in FIG. 2N. The image 226 may be scanned and optical character recognition implemented to extract textual information from the insurance card, such as a member ID, a group ID, and an RxBIN number, among other information. As previously discussed, in some embodiments, the tools to perform the scanning and optical character recognition may be built into the system 110. In other embodiments, a third party service may perform the scanning and optical character recognition and provide the extracted insurance information to the system 110.

As shown in FIG. 20, the extracted insurance information may be input directly into corresponding fields 230 of a payer information confirmation page 228, and displayed on the application user interface along with the image 226 of the insurance card. In some embodiments, as the insurance information is extracted, a verification process, such as an eligibility verification check, may be run in the background to ensure that the insurance information is valid and/or accurate. If any errors are detected, an error code 232 may be displayed to prompt the user to manually correct the insurance information that couldn't be extracted and/or that contained errors, as further shown in FIG. 20. The patient may then be asked to confirm that the insurance information input into each of the fields 230 is correct, where the patient can edit any of the fields 230 to correct errors by selecting an associated edit control 234, as shown in FIG. 2P. If the patient does edit any of the fields 230, the verification process may be re-run in the background to ensure that the edited insurance information is valid and/or accurate.

If the patient has more than one card associated with a payer (e.g., more than one insurance card), the application may prompt the patient to provide a picture of the additional card(s), as shown in FIG. 2Q. The application may provide the first, automatic take photo option 210 that utilizes the camera on the device 104 or the second, manual option 212 to enter information from the card. In an example scenario, a patient may have private health insurance but may also be on Medicare (e.g., because of their age). The patient may provide both insurance cards, which is helpful for the healthcare provider to track so that the insurance with the better coverage may be used for the procedure being registered.

If the first, automatic take photo option 210 is selected, a camera application may be executed on the device 104 allowing the camera to capture an image 236 of the additional insurance card, as shown in FIG. 2R. The image 236 may be scanned and optical character recognition implemented to extract textual information from the additional insurance card, and a verification process may be run in the background to ensure that the additional insurance information is valid and/or accurate. The additional insurance information may be input directly into the corresponding fields 230 of the payer information confirmation page 228 and displayed on the application user interface along with the image 236 of the insurance card, as shown in FIG. 2S. The patient may then be asked to confirm that the insurance information input into each of the fields 230 is correct, where the patient can edit any of the fields 230 to correct errors by selecting the associated edit control 234. If the patient does edit any of the fields 230, the verification process may be re-run in the background to ensure that the edited insurance information is valid and/or accurate.

As shown in FIG. 2T, once the patient's identity information and payer information have been provided and verified, the application may optionally display a confirmation page 238 and prompt the patient to proceed to confirm demographic information by selecting a “Let's confirm” control 240. As shown in FIG. 2U, the patient may be enabled to provide and/or update demographic information associated with the patient. The types of demographic information to be provided by the patient may vary widely based on the health care provider. Example demographic information may include name, telephone number, address, emergency contact information, employer information, ethnicity, and religious preference, among other types of similar information. Some of the demographic information, such as a name, telephone number, and/or address, that has already been identified and verified during the validation of the patient's identity, for example, may be saved and used to automatically populate the corresponding fields 242 so that the patient need only confirm the correctness of the information. Other demographic information, such as the emergency contact information, employer information, ethnicity, and religious preference, may need to be manually entered and confirmed by the patient using associated edit controls 244. The patient may select an “Update Information” control 246 in order to confirm the correctness of the automatically provided and/or manually entered demographic information and proceed with the self-registration process.

After the demographic information has been optionally been provided and/or updated, details associated with the appointment may be provided to the patient, as shown in FIG. 2V. The details may include a name of the health care provider 248, such as the doctor and the medical facility at which the appointment is taking place. The details may also include a date 250 and a time 252 of the appointment, where a selectable option 254 may be provided to add the appointment to a calendar of a calendaring application executing on the device 104, for example. By adding the appointment to the calendar, reminders may be set through the calendaring application, which may help the patient remember their upcoming appointment. In addition to providing the time 252 of the appointment, an estimated length of the appointment 256 is provided based on a type of the procedure associated with the appointment. For example, the procedure to surgically fix the patient's hand may take about two hours. This information may also be provided to the calendaring application, so that the calendar may block off that period of time in which the patient will be unavailable due to the appointment or procedure.

The details may further include an address 258 of the medical facility at which the appointment will take place, along with an estimated time 260 and a selectable option to “Get Directions” 262. The estimated time 260 may be the amount of time estimated for the patient to drive and/or take public transport to the address of the medical facility from their address (e.g., the address extracted from the driver's license or the address provided in the demographic information) on the day of and at the time of the appointment. In one example, the estimate may be obtained utilizing historical data for the particular day of the week and time of the day so that it matches a timeframe of when the patient would be planning to travel to the medical facility to more accurately simulate the traffic conditions. The selectable option to “Get Directions” 262 may provide the patient with step by step directions on how to get to the medical facility. In some embodiments, mapping tools may be built into the system 110 to provide these features. In other embodiments, a third party service, such as a web mapping service, may be utilized.

The details may yet further include an exact location of the appointment 264, as well as a description of and routing directions to a particular location near the medical facility where the patient is supposed to park 266. Medical facilities may have extremely larges campuses with multiple buildings and parking structures. Some of the parking structures may be designated for specific persons (e.g., staff, patients, or visitors) or for specific sections of the medical facility (e.g., surgery, emergency, and oncology). When patients get lost, it is not often because they are unaware of where the facility is, but instead because they are unsure of where to park. In some embodiments, the healthcare providers may geographically mark exactly where the patient should park in order to facilitate routing the patient to the correct location. In other embodiments, lay finding perspectives may be implemented.

Once the patient is able to review these above discussed details, the patient may tap a control 268 displayed on the application page to confirm, which sends a response to the system 110 and an optional response to service provider systems 114 (e.g., a health information system (HIS) of the healthcare provider) to indicate the patient has acknowledged that the details look correct and the patient will report for the appointment at that date and time. In some embodiments, positive, confidence-building facts 270 associated with healthcare provider (e.g., the doctor or the medical facility) may be provided to put the patient at ease. For example, as further illustrated in FIG. 2V, the patient may be informed that the surgical team won many awards in the past year for excellence in patient care.

Once the user has tapped to confirm the details of the appointment, the page displayed on the application user interface may update to show the appointment details along with an indication 272 that the appointment has been confirmed, as shown in FIG. 2W. In some examples, upon confirmation of the appointment, a payment notification 274 is provided to alert the patient that they have a copay due. The payment notification 274 may indicate an amount of the copay and an option to pay the copay now rather than at the time of the appointment (e.g., in order to avoid the line in the waiting room). If the patient selects the option to pay now, a dropdown menu 276 may be displayed through which the user may either scan 278 a payment option, such as a credit card, debit card, or check, or manually enter 280 the information associated with the payment option, as shown in FIG. 2X. To scan a credit card, for example, the patient may select to scan 278 and a camera application may be executed on the device 104 allowing the camera to capture an image of the credit card. The image may be scanned and optical character recognition implemented to extract the textual information from the credit card, such as a card number, expiration date, and card verification value, among other information. In some embodiments, the tools to perform the scanning and optical character recognition may be built into the system 110. In other embodiments, a third party service may perform the scanning and optical character recognition and provide the extracted information to the system 110.

Once payment information is provided automatically or manually, the patient may select a “Submit Payment” control 282. As shown in FIG. 2V, the payment notification 274 may be updated to show that the copay has been paid and an indication 284 that the payment has been received may be provided along with a confirmation number 286 to the patient. In some embodiments, a copy of the receipt may be automatically emailed 288 to the patient. For example, the patient may have provided their email address as part of the demographic information, which was saved and used to automatically send the receipt to the patient upon submission of the payment. In other embodiments, as shown in FIG. 22, the patient may be prompted to enter their email address within a corresponding field 290 in order to have a copy of the receipt emailed to them upon selection of an “Email Me” control 292.

In additional embodiments, a patient financial navigator similar to the system described in co-pending provisional application US 62/748,667 PRE-SERVICE PATENT NAVIGATION SYSTEM filed Oct. 22, 2018, which is incorporated herein by reference, may estimate a total amount that the patient will owe in addition to the copay for the particular procedure. The patient financial navigator may provide the estimate to the system 110, and the system 110 may display the estimate to the patient through the application. The estimate may be based on the type of the procedure, average costs the healthcare provider charges for the type of procedure, and the patient's insurance, among other similar data. For example, for the particular hand surgery, the patient may owe an estimated $742.15 out of a total $4,000 for the procedure. The system 110 may, similar to the copay, offer the patient an option to pay the estimated amount that they will owe prior to the procedure through the application.

The patient financial navigator may also determine how likely the estimate is to change, which may be provided to the system 110 for display to the patient. This may influence the patient's decision to pay now or later. For example, if the amount is likely to change, the patient may wait to avoid a scenario of overpayment and reimbursement and/or a scenario where two separate payments have to be made, especially if a service fee charge is attached to the payment.

The patient financial navigator may further provide information on reasoning behind the costs and different options available to the patient to help pay for the costs. To highlight the availability of these features to the patient, the system 110 may provide the patient an option (e.g., via a selectable link) to receive help with their financial experience. This option may be provided via a text message sent to the patient's device 104 or as a notification through the application. If the patient selects the link, the patient may be directed to an application associated with the patient financial navigator that explains the cost estimates to the patient and different mechanisms which the patient may use to finance the costs, such as charitable organizations or available loan packages.

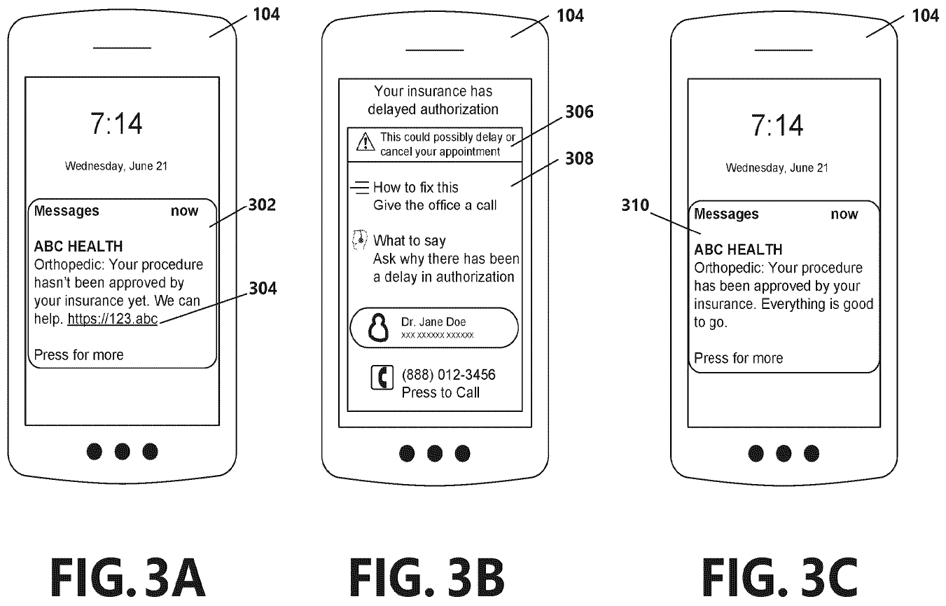

FIGS. 3A-3C illustrate example push notifications and application user interfaces associated with an authorization clearance phase of a self-registration process. The above processes discussed in conjunction with FIGS. 2A-2Z may occur shortly after the appointment has been scheduled and the patient has consented to participate in self-registration. Once the scheduled appointment draws near (e.g., somewhere between 3 and 14 days prior to the appointment), the system 110 may provide details associated with the authorization of the procedure being performed or care being provided, as shown in FIGS. 3A-3C.

Authorization involves an approval of the procedure or care by the patient's insurance company. Authorization is optimally provided to the healthcare provider prior to the date of the procedure to ensure the healthcare provider that they will be paid for their services. The referring physician (e.g., in our example scenario the urgent care physician who examined the X-ray and referred the patient to the specialist) is often responsible for initiating the authorization process with the patient's insurance company.

Often problems with authorization stem from the referring physicians failure to complete or lag in completing the necessary steps for authorization, which is largely because referring physicians are so inundated with patients and patient-related tasks (at least more so than a specialist). Accordingly, the process and timing of authorization may cause lot of delays and challenges to patients and healthcare providers alike. For example, because patients often request time off from work ahead of time for their procedure, it unsurprisingly frustrates the patient when they receive a call anywhere from 72 hours prior to the day of the appointment to reschedule because authorization has not yet been received. Additionally, from the healthcare provider's point of view, lack of timely authorization can cause a panic on the day of the appointment in trying to reach the referring physician to make sure they completed necessary steps for authorization and the authorization can be obtained.

To avoid these unnecessary and frustrating problems, the system 110 may monitor authorization and keep the patient and healthcare provider apprised of the authorization status. For example, if the authorization for the procedure has not yet been received from the insurance company, the system 110 may generate and transmit a push notification in a form of a text message 302 to the device 104 to inform the patient of the incomplete authorization status, as shown in FIG. 3A. The text message 302 may include a link 304 that upon selection executes the application on the patient's device 104.

A displayed page on the application user interface may provide a warning notification 306 that there has been a delay in the authorization of the insurance and prompt the patient to be proactive in resolving the problem to prevent delay or cancellation of the appointment, as shown in FIG. 3B. For example, the page may include information on how to fix the authorization delay 308, including which office or healthcare provider to call (e.g., often the referring physician) and what to say to get the information needed and/or to motivate the healthcare provider to complete the necessary steps. Additionally, this type of delay information may be collected, aggregated, and sent to medical facilities and/or healthcare providers to reveal which physicians are doing a good job of timely completing steps for authorization and those who are not. The medical facilities and/or healthcare providers may use this delay information to put pressure on the physicians they associate with to change their behavior, where this behavior maybe determinative of whether business relationships will continue or cease.

Once the authorization has been completed and the insurance company approves the procedure, the system 110 may generate and transmit another push notification in a form of a follow-up text message 310 to the patient's device 104 to indicate the approval, as shown in FIG. 3C.

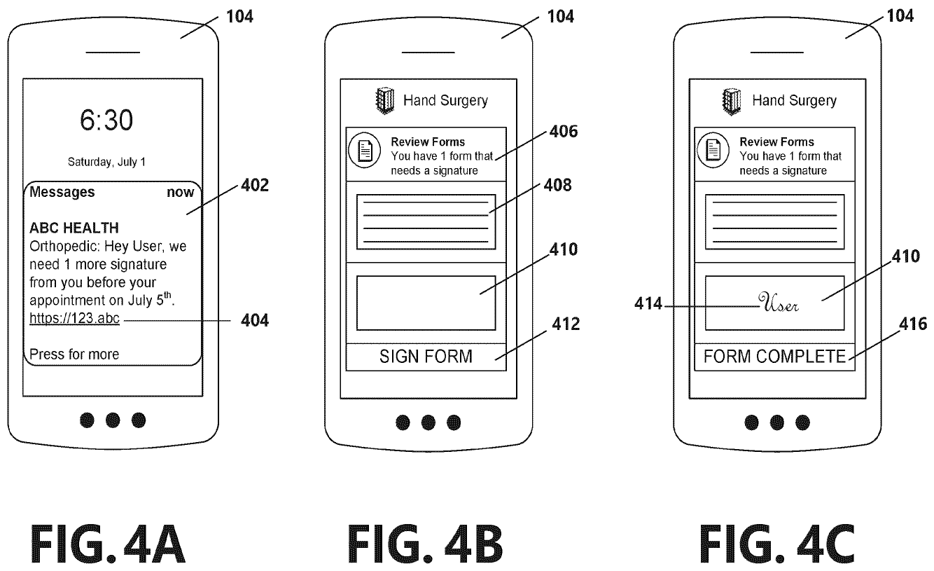

FIGS. 4A-4C illustrate example push notifications and application user interfaces associated with a form completion phase of a self-registration process. When the patient initially scheduled the appointment (e.g., with the receptionist at the referring physician's office), the patient may not have signed all or some of the consent forms, among other similar types of forms, required by the healthcare provider prior to performing the procedure. One or more days prior to the appointment, the system 110 may provide the patient an option to sign the form digitally through the application.

For example, the system 110 may generate and transmit a push notification in a form of a text message 402 to the device 104 to inform the patient that signatures on one or more required forms are still needed, as shown in FIG. 4A. The text message 402 may include a selectable link 404 that enables the user to view and sign the forms. Upon selection of the link 404, the application may be executed on the device 104. A page may be displayed on the application user interface that includes a review notification 406 indicating there may be one or more forms that the patient needs to sign prior to the rendering of the service, as shown in FIG. 4B. The content of the forms 408 may be provided, along with a signature area 410 capable of accepting input upon selection of a “Sign Form” control 412. Once the form has been reviewed and input within the signature area 410 has been received (e.g., a signature 414), the page may be updated to indicate the form is complete 416 as shown in FIG. 4C.

The system 110 may obtain the required forms from the healthcare provider, and scan the forms for storage in an internal forms database, for example, so that the forms may be readily retrieved and provided digitally to the patient through the application. In addition to consent and information release forms, medical-related forms may be provided to the patient digitally through the application in a similar manner, including pre-procedure and/or post procedure care instructions, which may or may not require a signature acknowledging the patient has read the instructions. For example, the form may instruct the patient that they should fast 24 hours prior to the procedure.

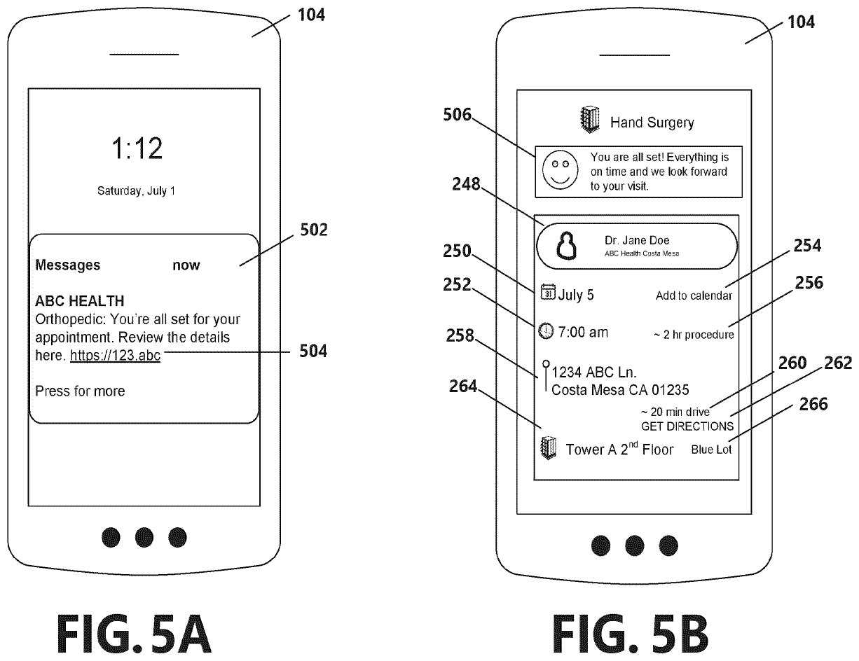

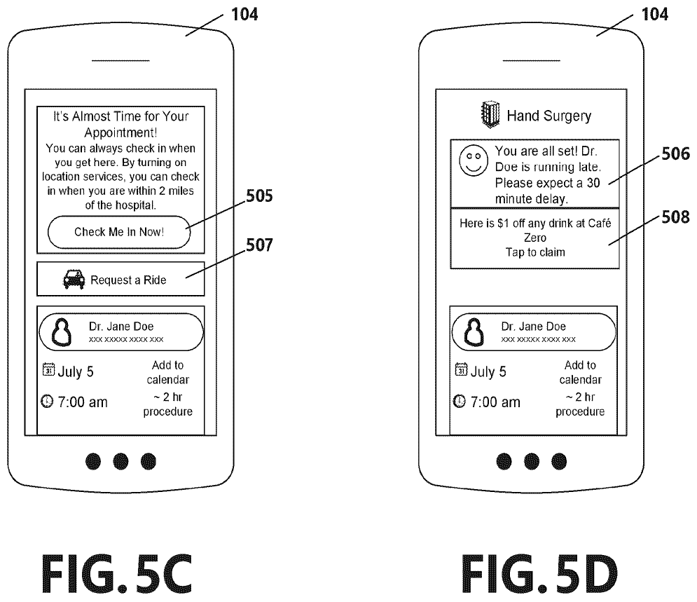

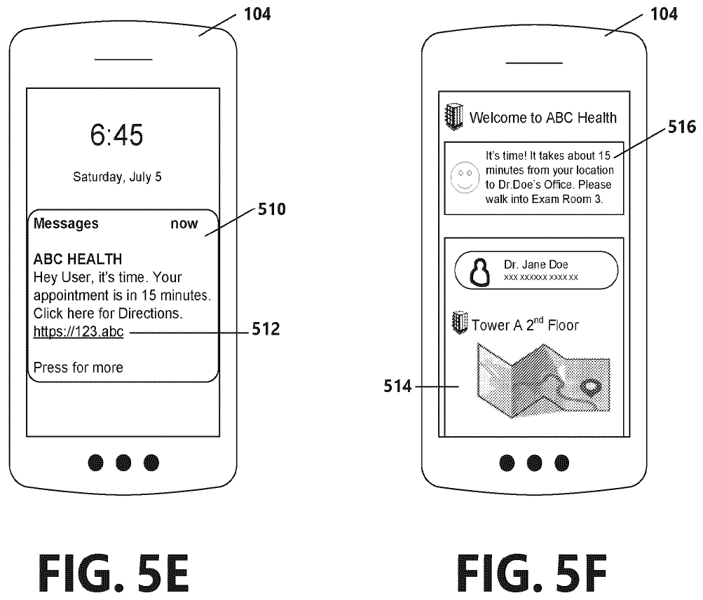

FIGS. 5A-5F illustrate example push notifications and application user interfaces associated with a post confirmation phase of a self-registration process.

About a day or so prior to the appointment, the system 110 may generate and transmit a push notification in a form of a text message 502 to the device 104 reminding the patient of the upcoming appointment, as shown in FIG. 5A. The text message 502 may include a selectable link 504 that enables the user to review the details of the appointment. For example, upon selection of the link 504, the application may be executed on the patient's device 104. The application may display a page that includes a notification 506 that everything is set for the appointment, along with appointment details, as shown in FIG. 5B. These appointment details include same or similar details discussed above in conjunction with FIG. 2V.

On the day of the appointment, the system 110 may provide additional features through the application that will help streamline the appointment check-in process to increase patient satisfaction and comfort. A main goal of this streamlining is to significantly limit and/or eliminate the time a patient spends in a waiting area or room, as these environments are often very uncomfortable for patients and can be a major source of frustration. For example, the waiting room may be full of sick individuals and a bit chaotic with physicians and patients shuffling in and out, which may increase an anxiety level of those patients waiting. This discomfort may be exponentially increased if any delays are experienced and the patient is forced to wait in an uncomfortable chair, bored, reading the same magazine over and over again, for example. Therefore, helping the patient to avoid spending time in a waiting area may be helpful in bettering the patient's overall experience on the day of the appointment.

One example is a digital check-in feature. For example and as illustrated in FIG. 5C, the system 110 may provide an option 505 for the patient to check in based on their geolocation through the application. For example, when the patient is routed to the appropriate parking area as discussed in conjunction with FIG. 2V or the patient is detected as being within certain geographical bounds of the appointment location within a predetermined time period prior to the appointment time, the patient may check in digitally through the application on the device 104. As a result, the patient no longer has to physically walk to the registrar or receptionist area prior to the appointment time to indicate that they are present for their appointment. By not having to physically be present to check in, a patient may choose to wait in a more comfortable setting, such as their car or a cafe near the appointment location, where they may have less anxiety and the ability to better entertain themselves.

Another feature that may be provided by the system 110 via the application is a transportation option 507. Selection of the transportation option 507 may call a transportation tool built into the system 110 or provided by a third party service (e.g., via an application programming interface (API)). In some examples, the transportation tool may be configured to provide public transportation options to the location of the appointment. For example, based on the patient's current geolocation, the transportation tool may be configured to search for nearby public transportation stations, provide public transportation information (e.g., transit lines, departure times), and determine an estimated time of arrival based on the public transportation information. In other examples, the transportation tool may enable the patient to select a pick-up and/or drop-off location (or the transportation tool may automatically fill in the pick-up and drop-off locations based on the patient's current geolocation and the location of the appointment, respectively), view time and price estimates, request a ride, etc. For example, functionality of a third party ride-hailing or ride-sharing service may be integrated into the application; or, the transportation option 507 may provide a link to a third party ride-hailing or ride-sharing service.

Additionally, as shown in FIG. 5D, the notification 506 provided on the appointment details page may be updated to inform the patient of any delays that the healthcare provider is experiencing, including an estimated timing of the delay. For example, the notification 506 may indicate a thirty minute delay to the scheduled appointment time. This allows the patient the opportunity to avoid wasting their time during the delay. For example, the patient may utilize this information to leave their home at a later time for the appointment or spend additional time waiting elsewhere near the appointment location, such as their car or the cafe, that provides a less stressful or uncomfortable environment than the waiting room.

In some embodiments, health care providers may choose to provide a monetary or other similar offers to the patient through the application when they are experiencing delays. These offers may be incentives to help offset any patient frustration caused by the delay. For example, as further illustrated in FIG. 5D, an offer 508 of a coupon to a coffee shop near the appointment location may be provided to the patient through the application. If the patient accepts the offer 508 by clicking or tapping on the offer 508, the offer 508 may be emailed and/or texted to the patient, among other options. In some instances, the offer 508 may be beverage or food-related, but the patient may not be allowed to drink or eat at that time based on pre-procedure instructions. In those instances, a notification may be provided along with the offer 508 that indicates the offer 508 may be saved and used at a later time since they are currently fasting based on pre-procedure instructions. This helps serve as a reminder to the patient that they are unable to eat or drink at this time, and ensures that they will be able to utilize the offer 508 to keep patient satisfaction up.

On the other hand, if the patient is late for the scheduled appointment, the healthcare provider may utilize the system 110 to prompt the patient to provide an updated status to the healthcare provider. For example, a text message may be sent to the patient that includes a link, where upon selection of the link, the patient is enabled to inform the healthcare provider of their estimated time of arrival through the application. Additionally, if the patient knows they are or will be running late, the patient may proactively update the healthcare provider through the application.

As the appointment time draws near, a push notification in a form of a text message 510 may be generate and transmitted to the device 104 to inform the patient that the appointment is about to start is, as shown in FIG. 5E. The transmission timing of the text message 510 may be based on a current location of the patient relative to the location of the appointment. For example, if the patient's current location is a fifteen minute walk from the appointment location, the text message may be provided to the patient fifteen minutes prior to the start time of the appointment. The text message 510 may also include a selectable link 512 to provide the patient directions to the location of the appointment. In some embodiments, the directions may route the patient directly to the exam or procedure room, which allows the patient to bypass any sort of registrar, reception or waiting room. For example, upon selection of the link 512, directions 514 are provided from the current location of the patient directly to the exam room, as shown in FIG. 5F. Instructions 516 may be provided in conjunction with the directions regarding which specific exam room to enter. These directions 514 and instructions 516 may ensure the patient does not get lost or does not waste time aimlessly wandering around a large medical facility.

To obtain accurate directions for routing patients directly to exam or procedure rooms, the system 110 may simply request healthcare providers to take pictures of one or more paths that may be used by patients to access the various exam or procedures rooms. Alternatively, more complex geolocation techniques may be employed. In some embodiments, mapping tools may be built into the system 110 to provide these features. In other embodiments, a third party service, such as a web mapping service, may be utilized.

The example post notifications and application user interfaces provided above in FIGS. 2A-SF are for illustrative purposes only, and are not intended to be limiting. Additional or alternative textual schemes, graphical schemes, audio schemes, animation schemes, coloring schemes, highlighting schemes, and/or shading schemes may be utilized to enhance the display within the post notifications and application user interfaces.

FIGS. 6A-6E represent a flow chart showing general stages involved in

an example method for self-registration. As illustrated in FIG. 6A, the method may begin when an appointment for a patient service is scheduled within an HIS associated with a healthcare provider at OPERATION 600. For example, a scheduler may schedule an appointment as an event in the HIS. The HIS may be one of the service provider systems 114 communicatively coupled to the system 110, and the event may be sent from the HIS to the system 110. The event may be sent as a message that includes scheduling information associated with the appointment. As another example, an appointment for a patient service may be initiated by a patient or another user on behalf of the patient using an application associated with the system 110. For example, a thin version of the application or a thick version of the application may be executed on a device 104, which may be configured to provide a user interface for display on the device via which scheduling information can be input for scheduling a service appointment. The scheduling information may include details about the patient (e.g., demographic information, identifying information), the procedure being performed or care being provided in association with the appointment, a date and a time of the appointment, which physician is performing the procedure or providing the care, reason for visit, and insurance/payer information, among other similar information.

The system 110 may receive the message from the HIS over a secured virtual private network (VPN), and may process and normalize the message into a common format, such as XML, at OPERATION 602. The system 110 (e.g., a rules engine of the system 110) may evaluate the message according to one or more rules to determine whether certain criteria is met for the patient to qualify for self-registration at DECISION 604. The criteria may vary widely based on the particular healthcare provider. The criteria may be based on a type of procedure or one or more characteristics of the patient. For example, a healthcare provider may not want a certain patient population or certain services to qualify for self-registration because direct contact with the patients may be important to communicate information about the services and/or get additional information from them.

If the criteria is not met, and the patient does not qualify for self-registration, a flag may be produced in the system 110 that indicates the patient does not qualify and thus, the healthcare provider will need to follow-up with this patient manually. For example, self-registration may be flagged as incomplete at OPERATION 606 and the system 110 may notify the healthcare provider. If the criteria is met, and the patient does qualify for self-registration, the patient may be notified and provided an option to opt-out of the self-registration at DECISION 608. The patient may be notified and provided the option to opt-out via a text message or other similar push notification transmitted to a mobile device of the patient, where selection of a link in the text message may launch an application associated with the system 110 that is configured to guide the patient through the self-registration process. If the patient selects the option to opt-out of the self-registration, then the self-registration may be flagged as incomplete at OPERATION 606 and the system 110 may notify the healthcare provider. If the patient does not select the option to opt-out, the self-registration process may be initiated through the application at OPERATION 609.

As illustrated in FIG. 6B, upon initiation of the self-registration process,

the system 110 may prompt the patient to take a picture of a photo identification card, and receive the picture taken by the patient using a camera on their mobile device at OPERATION 610. The system 110 may perform a validation check to determine whether or not the identification information provided is valid at DECISION 612. If the validation check is not passed, the patient may be provided the option to try an alternate photo identification card at DECISION 614. In some examples, the patient may be given an indefinite amount of attempts to try alternative photo identification cards. In other examples, a limit may be set on a number of attempts allowed. If the patient chooses to try an alternative, the system 110 may receive a picture of the alternative photo identification card taken by the patient at OPERATION 610. The system 110 may perform a validation check at DECISION 612 to determine whether or not the alternative identification information provided is valid. This process of alternative identification provision and validation may be repeated one or more times as discussed above. If the validation checks fail and no alternative photo identification cards are left to provide (or the number of attempts has been reached), then the self-registration may be flagged as incomplete at OPERATION 606 and the system 110 may notify the healthcare provider.

If at least one of the validation checks is passed, the system 110 may implement optical character recognition to extract data from the validated identification card at OPERATION 616. In some embodiments, an application programming instance (API) of a third party service may be utilized by the system 110 to perform the optical character recognition and data extraction. The extracted data may include the patient's name, address, date of birth, and a driver's license number or ID number, among other similar information. The extracted data may be stored locally in a database of the system 110 at OPERATION 618. The system 110 may use this stored data to automatically populate forms, as discussed below, and may also send a copy of the stored data to the patient if requested. At OPERATION 620, the system 110 may prompt the patient to provide information in order to verify the identity of the person self-registering at DECISION 622. For example, the system 110 may prompt the patient to take a self-portrait photograph (e.g., a “selfie) and receive the selfie taken by the patient using the camera on their mobile device to verify the person whose identification information was provided via the one or more photo identification cards matches the person in the selfie. As another example, the system 110 may prompt the patient to provide other information that can be used for verification, such as an authentication code 229 pushed to the patient, answers to one or more security questions 225, etc. In some embodiments, an (API) of an identity verification service may be utilized by the system 110 to perform the verification. If the verification fails, then the self-registration may be flagged as incomplete and the system 110 may notify the healthcare provider at OPERATION 606.

If the patient's identity is verified, then the system 110 may ask the patient for insurance information (e.g., ask whether the patient has insurance or not) at OPERATION 624, as illustrated in FIG. 6C. If the patient indicates that they do not have insurance, then the self-registration may be flagged as incomplete at OPERATION 606 and the system 110 may notify the healthcare provider. If the patient does have insurance, the system 110 may prompt the patient to take a picture of their insurance card, and receive the picture taken by the patient using the camera of their mobile device at OPERATION 626. The system 110 may implement optical character recognition to extract data from the insurance card and run the data through an internal eligibility verification check at OPERATION 628 in order to determine whether the insurance information is valid at DECISION 630.

If the validation check fails, the patient may be asked for an alternate insurance card at OPERATION 632 or to correct any errors in the information initially provided. For example, the patient may have accidentally used an old insurance card or took a bad picture. OPERATION 626, OPERATION 628, and DECISION 630 may be repeated if the user selects the option to try an alternate card or provides corrections. Similar to the attempts with the photo identification cards, the patient may be given an indefinite amount of attempts to try alternative insurance cards. In other examples, a limit will be set on a number of attempts allowed. If the insurance information cannot be validated, then the self-registration may be flagged as incomplete at OPERATION 606 and the system 110 may notify the healthcare provider.

If the original insurance card or any of the alternative insurance cards are validated, the system 110 may inquire whether the patient has any additional insurance at DECISION 634. If the patient has additional insurance, OPERATION 626, OPERATION 628, DECISION 630, and optionally OPERATION 632 may be performed to receive and validate the additional insurance information. If the patient has no additional insurance or once all of the patient's additional insurance has been received and validated, the data extracted from the insurance cards may be stored in the local database of the system 110 at OPERATION 636.

Validation of the insurance information is important because patients may make mistakes about the information they provide or enter. For example, patients may not be frequent customers of healthcare and unfamiliar with the healthcare system in general causing them to provide incorrect insurance information, among other information. For example, a patient may accidentally capture an image of or manually enter information from a pharmacy loyalty card instead of their insurance card. Obtaining objective insurance data is important in making sure the healthcare provider is billing the right payer and has the accurate information to do so.

As illustrated in FIG. 6D, the system 110 may retrieve any forms that may be required to be reviewed and signed prior to the appointment at OPERATION 638. Required forms may include consent forms or release of information forms, among other examples. The system 110 may obtain these forms from the healthcare provider and store them in a supplemental forms database so that the forms can be easily retrieved, as shown at OPERATION 640.

The system 110 may automatically populate a retrieved form at OPERATION 642 using data retrieved from the local database, such as the data associated with the patient's identification and insurance, at OPERATION 644. The automatically populated form may be provided to the patient at OPERATION 646 and a determination as to whether all necessary fields on the form are complete is made at DECISION 648. If not all fields are complete or there are errors, the patient may be prompted to edit the form at OPERATION 650. If all the fields are complete or it is determined that all the fields are complete following one or more edits made by the patient at DECISION 652, the patient may be prompted to sign the form at OPERATION 654. If for some reason the required forms are unable to be completed, then the self-registration may be flagged as incomplete at OPERATION 606 and the system 110 may notify the healthcare provider.

Once the user signs the form, the system 110 may send the completed and executed form to the healthcare provider at OPERATION 656. For example, the completed and executed form may be sent to a document imaging system of the health care provider (e.g., one of the service provider systems 114). A determination may be made as to whether additional forms are required to be completed and signed at DECISION 658. If there are additional forms, then OPERATIONS and DECISIONS 642-658 may be repeated until no additional forms are left to be completed and signed.

As shown in FIGURE GE, once no additional forms remain, the system 110 may provide the patient with appointment details and prompt the patient to confirm the appointment details at DECISION 660. If the patient fails to confirm the appointment details, then the self-registration may be flagged as incomplete at OPERATION 606 and the system 110 may notify the healthcare provider. If the patient confirms the appointment details, then the system 110 may confirm the appointment internally at OPERATION 662. For example, the appointment may be confirmed in a patient access workflow system, which may be an integrated platform that automates manual patient access processes, including orders, registration, and financial clearance. Additionally, the system 110 may notify the healthcare provider of the confirmation at OPERATION 664. For example, saving the appointment details internally may trigger a postback to the HIS associated with the healthcare provider, where the postback or other similar action may flag that the self-registration is complete within the HIS. The self-registration process may then be completed at OPERATION 666.

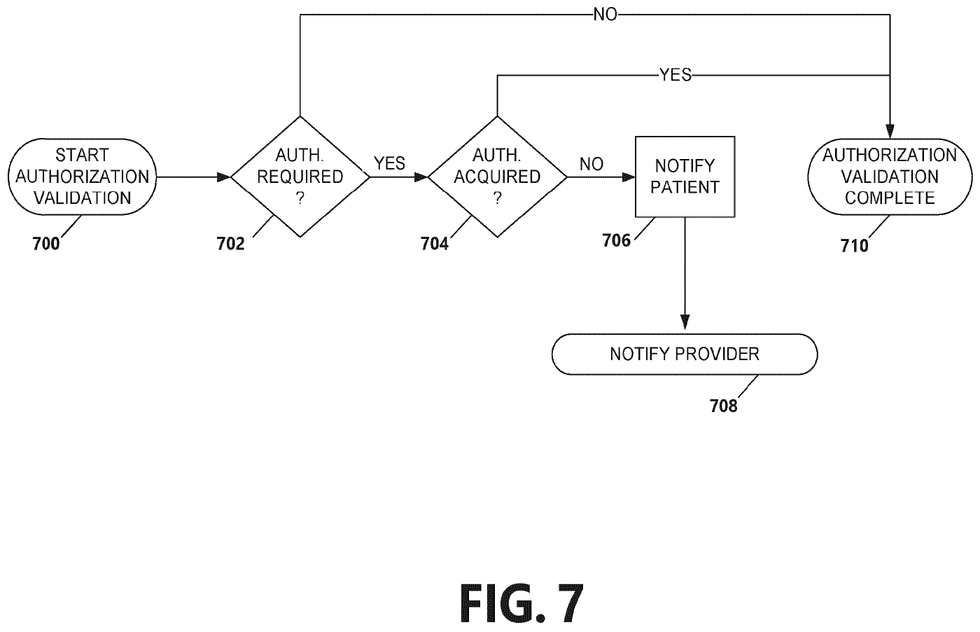

FIG. 7 is a flow chart showing general stages involved in an example method for monitoring and facilitating authorization. Authorization involves an approval by a patient's insurance company of a procedure to be performed or care to be provided by a health care provider. In many cases, a referring physician rather than the physician performing the procedure or providing the care is the responsible party for initiating the authorization process with the patient's insurance company. Authorization may happen concurrently with, but is performed separately from the self-registration process described above in conjunction with FIGS. 6A-6E. However, most often authorization occurs later in time (that is, closer to the appointment) than the self-registration. It is critical for authorization to be completed prior to the date of the appointment in order to avoid any last-minute delays that may require rescheduling of the appointment.

At OPERATION 700, which will occur prior to the date of appointment, the system 110 may validate the authorization (e.g., perform an authorization clearance). For example, a rules engine of the system 110 may determine if authorization is required at DECISION 702. If an authorization is not required, the authorization validation is completed at OPERATION 710. A text message may be generated and transmitted to the patient's device 104 informing the patient that the procedure or care associated with their upcoming appointment has been approved, as illustrated in FIG. 3C, for example.

If an authorization is required, the system 110 determines whether or not the authorization has been acquired at OPERATION 704. If the authorization has been acquired, the authorization validation is completed at OPERATION 710, and the patient may be notified via text message that the procedure or care associated with their upcoming appointment has been approved, as illustrated in FIG. 3C, for example. If the authorization has not been acquired yet, the system 110 may notify the patient at OPERATION 706 about steps to take in order to facilitate authorization.

For example, a text message may be generated and transmitted to the patient's device 104 informing the patient that the procedure or care associated with their upcoming appointment has not yet be approved. Selection of a link within the text message launches a page of an application associated with the system 110 that informs the patient about what steps to take, as illustrated in FIGS. 3A and 3B, for example. Additionally, at OPERATION 708, the system 110 may notify the staff of the party responsible for initiating the authorization and/or the staff of the healthcare provider performing the procedure or providing the care associated with the upcoming appointment that the authorization hasn't been obtained yet and the patient has also been informed.

Following the notifications provided at OPERATIONS 706 and 708, the system 110 may periodically check to determine whether the authorization has been acquired (e.g., return to OPERATION 704). Once the authorization is eventually acquired, the authorization validation may be completed at OPERATION 710, and the patient may be notified via text message that the procedure or care associated with their upcoming appointment has been approved, as illustrated in FIG. 3C, for example.

The examples provided in the above discussed figures are illustrated with specific systems, services, applications, devices, processes, push notifications and application user interfaces. Embodiments are not limited to environments according to these examples. A self-registration system may be implemented in environments employing fewer or additional systems, services, applications, devices, processes, push notifications and application user interfaces. Furthermore, the example systems, services, applications, devices, processes, push notifications and application user interfaces shown in the above figures may be implemented in a similar manner with other values using the principles described herein.

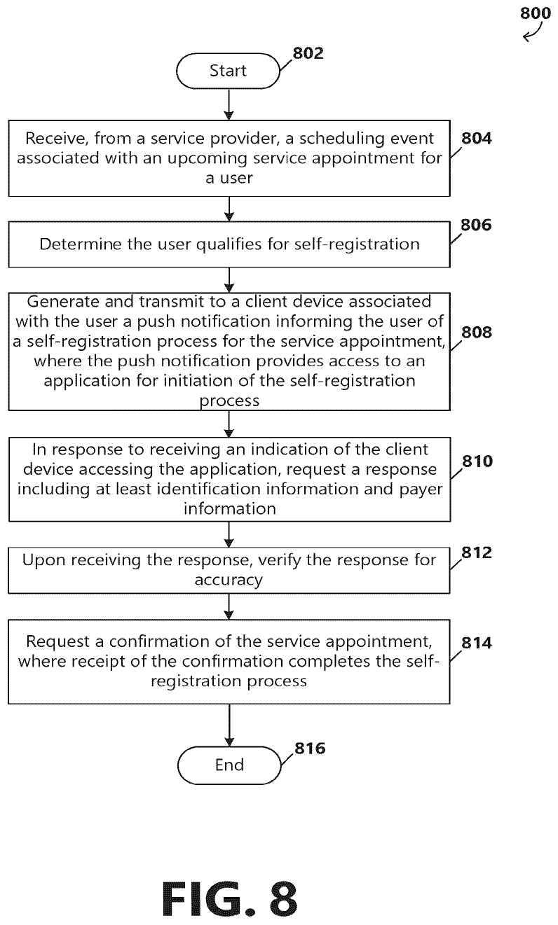

FIG. 8 illustrates an example method, performed by a self-registration system 110, for providing a digital self-registration experience. The method 800 begins at START OPERATION 802. A scheduling event associated with an upcoming service appointment for a user 102 may be received from a service provider at OPERATION 804. The system 110 may be communicatively coupled to one or more service provider systems 114 to facilitate the communication of the scheduling event. The user 102 may be determined to qualify for self-registration at OPERATION 806. In some examples, the user may be determined to qualify for self-registration upon a determination that one or more criterion stipulated by the service provider are met. The criterion may be based a type of service associated with the service appointment and/or one or more characteristics of the user.

At OPERATION 808, a push notification informing the user 102 of a self-registration process for the service appointment is generated and transmitted to a client device (e.g., device 104) associated with the user 102. The push notification may provide access to an application for initiation of the self-registration process. In some examples, the push notification may be transmitted to the client device as a text message (e.g., text message 202), where the text message includes a link (e.g., link 204) that may be selected to access the application.

In response to receiving an indication of the client device accessing the application (e.g., upon detecting a selection of the link 204), a response including at least identification information and payer information may be requested at OPERATION 810. In some examples, the identification information and the payer information include information associated with a photo identification card and a card associated with a payer. Within the request, a first option (e.g., a first, automatic take photo option 210) may be provided for automatic capture of an image of the photo identification card and the card associated with the payer using a camera of the client device. Additionally, a second option (e.g., second, manual option 212) may be provided for manual entry of information associated with the photo identification card and the card associated with the payer.

Upon receiving the response, the response may be verified for accuracy at OPERATION 812. For example, if the first option is selected, the image of the photo identification card (e.g., image 214) and the image of the card associated with the payer (e.g., images 226 and/or 236) captured by the camera of the client device may be received, and a check is performed to validate the photo identification card and the card associated with the payer. If validated, the identification information and the payer information from the validated photo identification card and the validated card associated with the payer may be extracted and stored locally. Additionally, upon validation of the photo identification card, identity verification information may be requested. For example, a self-portrait photograph to be captured by the camera of the client device may be requested, and upon receipt of the captured self-portrait photograph (e.g., self-portrait photograph 222), a self-portrait photograph within the received image of the photo identification card is matched to the captured self-portrait photograph to further verify the identification information. Alternatively, if the second option is selected, a check is performed to validate the manually entered information, which is then stored locally upon validation.

At OPERATION 814, a confirmation of the service appointment may be requested, where receipt of the confirmation completes the self-registration process. In some embodiments, the service provider may be notified of the completion of the self-registration process. The method 800 ends at OPERATION 816.

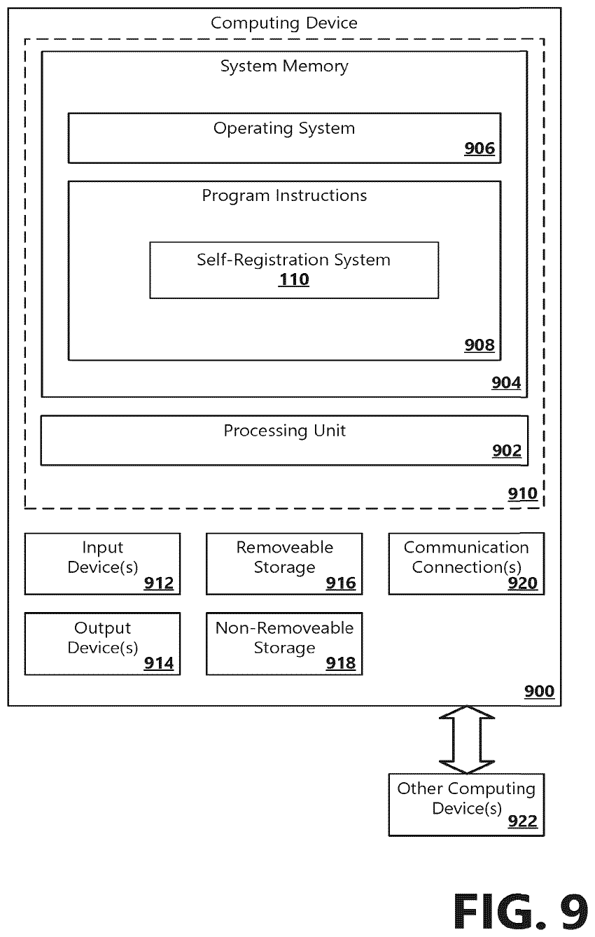

FIG. 9 is a block diagram illustrating physical components of an example computing device with which aspects may be practiced. The computing device 900 may include at least one processing unit 902 and a system memory 904. The system memory 904 may comprise, but is not limited to, volatile (e.g. random access memory (RAM)), non-volatile (e.g. read-only memory (ROM)), flash memory, or any combination thereof. System memory 904 may include operating system 906, one or more program instructions 908, and may include sufficient computer-executable instructions for a self-registration system 110, which when executed, perform functionalities as described herein. Operating system 906, for example, may be suitable for controlling the operation of computing device 900. Furthermore, aspects may be practiced in conjunction with a graphics library, other operating systems, or any other application program and is not limited to any particular application or system. This basic configuration is illustrated by those components within a dashed line 910. Computing device 900 may also include one or more input device(s) 912 (keyboard, mouse, pen, touch input device, etc.) and one or more output device(s) 914 (e.g., display, speakers, a printer, etc.).

The computing device 900 may also include additional data storage devices (removable or non-removable) such as, for example, magnetic disks, optical disks, or tape. Such additional storage is illustrated by a removable storage 916 and a non-removable storage 918. Computing device 900 may also contain a communication connection 920 that may allow computing device 900 to communicate with other computing devices 922, such as over a network in a distributed computing environment, for example, an intranet or the Internet. Communication connection 920 is one example of a communication medium, via which computer-readable transmission media (i.e., signals) may be propagated.

Programming modules may include routines, programs, components, data structures, and other types of structures that may perform particular tasks or that may implement particular abstract data types. Moreover, aspects may be practiced with other computer system configurations, including hand-held devices, multiprocessor systems, microprocessor-based or programmable user electronics, minicomputers, mainframe computers, and the like. Aspects may also be practiced in distributed computing environments where tasks are performed by remote processing devices that are linked through a communications network. In a distributed computing environment, programming modules may be located in both local and remote memory storage devices.

Furthermore, aspects may be practiced in an electrical circuit comprising discrete electronic elements, packaged or integrated electronic chips containing logic gates, a circuit using a microprocessor, or on a single chip containing electronic elements or microprocessors (e.g., a system-on-a-chip (So( )). Aspects may also be practiced using other technologies capable of performing logical operations such as, for example, AND, OR, and NOT, including, but not limited to, mechanical, optical, fluidic, and quantum technologies. In addition, aspects may be practiced within a general purpose computer or in any other circuits or systems.

Aspects may be implemented as a computer process (method), a computing system, or as an article of manufacture, such as a computer program product or computer-readable storage medium. The computer program product may be a computer storage medium readable by a computer system and encoding a computer program of instructions for executing a computer process. Accordingly, hardware or software (including firmware, resident software, micro-code, etc.) may provide aspects discussed herein. Aspects may take the form of a computer program product on a computer-usable or computer-readable storage medium having computer-usable or computer-readable program code embodied in the medium for use by, or in connection with, an instruction execution system.

Although aspects have been described as being associated with data stored in memory and other storage mediums, data can also be stored on or read from other types of computer-readable media, such as secondary storage devices, like hard disks, floppy disks, or a CD-ROM, or other forms of RAM or ROM. The term computer-readable storage medium refers only to devices and articles of manufacture that store data or computer-executable instructions readable by a computing device. The term computer-readable storage media does not include computer-readable transmission media.

Aspects of the present invention may be used in various distributed computing environments where tasks are performed by remote processing devices that are linked through a communications network.

Aspects of the invention may be implemented via local and remote computing and data storage systems. Such memory storage and processing units may be implemented in a computing device. Any suitable combination of hardware, software, or firmware may be used to implement the memory storage and processing unit. For example, the memory storage and processing unit may be implemented with computing device 900 or any other computing devices 922, in combination with computing device 900, wherein functionality may be brought together over a network in a distributed computing environment, for example, an intranet or the Internet, to perform the functions as described herein. The systems, devices, and processors described herein are provided as examples; however, other systems, devices, and processors may comprise the aforementioned memory storage and processing unit, consistent with the described aspects.

The description and illustration of one or more aspects provided in this application are intended to provide a thorough and complete disclosure of the full scope of the subject matter to those skilled in the art and are not intended to limit or restrict the scope of the invention as claimed in any way. The aspects, examples, and details provided in this application are considered sufficient to convey possession and enable those skilled in the art to practice the best mode of the claimed invention. Descriptions of structures, resources, operations, and acts considered well-known to those skilled in the art may be brief or omitted to avoid obscuring lesser known or unique aspects of the subject matter of this application. The claimed invention should not be construed as being limited to any embodiment, aspects, example, or detail provided in this application unless expressly stated herein. Regardless of whether shown or described collectively or separately, the various features (both structural and methodological) are intended to be selectively included or omitted to produce an embodiment with a particular set of features. Further, any or all of the functions and acts shown or described may be performed in any order or concurrently. Having been provided with the description and illustration of the present application, one skilled in the art may envision variations, modifications, and alternate embodiments falling within the spirit of the broader aspects of the general inventive concept provided in this application that do not depart from the broader scope of the present disclosure.

1.-20. (canceled)

21. A digital self-registration system comprising:
a processor; and
at least one non-transitory computer-readable medium having stored thereon instructions that, when executed by the processor, cause the processor to:
receive, via an interface portal, a scheduling event from a service provider system of a plurality of service provider systems, the scheduling event associated with a service appointment for a user;
convert the scheduling event to a standardized scheduling event using a first standardized format associated with service provider events and for use with the plurality of service provider systems, the standardized scheduling event including service provider information;
extract a service provider identifier from the scheduling event;
access a set of self-registration rules associated with the service provider identifier, wherein the set of self-registration rules are generated based on at least one of procedure type or patient characteristic;
apply one or more rules of the set of self-registration rules to determine the user qualifies for self-registration;
automatically generate a first push notification comprising:
an electronic notification message informing the user of a self-registration process for the service appointment, and a first embedded access link to a self-registration application associated with the system for initiation of the self-registration process;
automatically send the first push notification to a network service for transmission to a messaging component associated with the user for display on one or more client devices associated with the user;
in response to transmitting the first push notification to the network service and receiving an indication of the one or more client devices accessing the self-registration application, request a response including at least identification
information and benefits provider information, wherein identification information comprises information associated with a photo identification card, and wherein benefits provider information comprises information associated with a patient insurance card;
receive the response comprising received identification information and received benefits provider information;
convert the received identification information to a standardized identification information using a second standardized format associated with identity information, the second standardized format for use with identification information of different users and convert the received benefits provider information to a standardized benefits provider information using a third standardized format associated with benefits provider information, the third standardized format for use with benefits provider information of different benefits providers;
conduct an identity verification check using the standardized identification information to determine whether the standardized identification information is valid;
conduct a security check by requesting answers to one or more security questions, the one or more security questions based on one or more of: demographic information, answers to questions previously provided by the user, credit profile data, or public information;
after receiving one or more answers to the one or more security questions, verify the one or more answers by comparing the one or more answers to known information to determine if the one or more answers are valid;
conduct a benefits provider verification check using the standardized benefits provider information to determine whether the standardized benefits provider information is valid;
after determining that the standardized identification information is valid, determining that the standardized benefits provider information is valid, and determining that the one or more answers are valid, automatically transmit to the one or more client devices, via the self-registration application associated with the user, a request for confirmation of the service appointment, wherein receipt of the confirmation completes the self-registration process; and
in response to receiving the confirmation, provide a notification to the service provider system to indicate the self-registration process is completed.

22. The digital self-registration system of claim 21, wherein the instructions, when executed, further cause the processor to:
on a date of the service appointment and within a predetermined time period before a time of the service appointment, receive a current location of the user from the one or more client devices; and
in response to determining the current location of the user is geographically proximate to a location of the service appointment, generate and transmit to the one or more client devices a second push notification informing the user of a digital check-in process for the service appointment, wherein the second push notification provides access to the self-registration application for initiation of the digital check-in process.

23. The digital self-registration system of claim 22, wherein the instructions, when executed, further cause the processor to:
provide directions from the current location of the user to the location of the service appointment as part of the digital check-in process, wherein the directions are provided a predetermined amount of time prior to the time of the service appointment based on an estimated travel time from the current location of the user to the location of the service appointment.

24. The digital self-registration system of claim 21, wherein the instructions, when executed, further cause the processor to:
determine the user has not completed one or more forms required by the service provider system;
generate and transmit to the one or more client devices a second push notification informing the user of the one or more forms to be completed, wherein the second push notification provides access to the self-registration application for completion of the one or more forms;
in response to receiving an indication of the one or more client devices accessing the self-registration application, automatically populate at least a portion of the one or more forms using data stored in a local database of the system; and
upon detecting a completion of the one or more forms, provide the completed one or more forms to the service provider system.

25. The digital self-registration system of claim 21, wherein the instructions, when executed, further cause the processor to:
monitor whether a service being performed in association with the service appointment has been authorized by a benefits provider; and
notify one or more of the user and the service provider system if the service appointment has not been authorized.

26. The digital self-registration system of claim 21, wherein the instructions, when executed, further cause the processor to:
provide one or more details associated with the service appointment, wherein:
the one or more details include a name of the service provider system, a date of the service appointment, a time of the service appointment, an estimated duration of the service appointment, an address of the service appointment, or a parking location, and
the one or more details are initially provided in conjunction with the request to confirm the service appointment and subsequently provided a predetermined period of time before the date of the service appointment to remind the user of the service appointment.

27. The digital self-registration system of claim 21, wherein the instructions, when executed, further cause the processor to:
provide a date of the service appointment, a time of the service appointment, and an estimated duration of the service appointment to a calendaring application executing on the one or more client devices to enable the service appointment to be added to a calendar.

28. The digital self-registration system of claim 21, wherein the instructions, when executed, further cause the processor to:
based on an address of the service appointment and a location of the user, provide:
an estimated travel time; and
directions from the location of the user to one or more of the address of the service appointment or a parking location, wherein the location of the user is a current location of the user or a location determined from the identification information.

29. The digital self-registration system of claim 21, wherein the instructions, when executed, further cause the processor to:
receive, from the service provider system, information related to a delay associated with the service appointment, wherein the information includes one or more of an estimated duration of the delay and an incentivization offer; and
generate and transmit another push notification informing the user of the delay and providing the incentivization offer to the one or more client devices.

30. The digital self-registration system of claim 21, wherein to request the response, the instructions, when executed, further cause the processor to provide at least one of:
a first option for automatic capture of an image of the photo identification card and the patient insurance card using a camera of the one or more client devices; and
a second option for manual entry of information associated with the photo identification card and the patient insurance card.

31. The digital self-registration system of claim 30, wherein if the first option is selected, to verify the response for accuracy, the instructions, when executed, further cause the processor to:
receive the image of the photo identification card and the image of the patient insurance card captured by the camera of the one or more client devices;
perform a check to validate the photo identification card and the patient insurance card; and
extract the identification information and the benefits provider information from the validated photo identification card and the validated patient insurance card for storage in a local database of the system.

32. The digital self-registration system of claim 31, wherein, to verify the response for accuracy, the instructions, when executed, further cause the processor to:
upon validation of the photo identification card, request a self-portrait photograph to be captured by the camera of the one or more client devices; and
upon receipt of a captured self-portrait photograph, match a photograph within the received image of the photo identification card to the captured self-portrait photograph to further validate the identification information.

33. The digital self-registration system of claim 21, wherein the system hosts a text-to-mobile service and the first push notification is a text message providing access to the self-registration application via a selectable link.

34. The digital self-registration system of claim 21, wherein the system is coupled to one or more systems associated with the service provider system to facilitate communication.

35. A method for providing a digital self-registration experience, the method comprising:
receiving, via an interface portal, a scheduling event from a service provider system of a plurality of service provider systems, the scheduling event associated with a service appointment for a user;
converting the scheduling event to a standardized scheduling event using a first standardized format associated with service provider events and for use with the plurality of service provider systems, the standardized scheduling event including service provider information;
extracting a service provider identifier from the scheduling event;
accessing a set of self-registration rules associated with the service provider identifier, wherein the set of self-registration rules are generated based on at least one of procedure type or patient characteristic;
applying one or more rules of the set of self-registration rules to determine the user qualifies for self-registration;
automatically generating a first push notification comprising:
an electronic notification message informing the user of a self-registration process for the service appointment, and a first embedded access link to a self-registration application associated with the system for initiation of the self-registration process;
automatically sending the first push notification to a network service for transmission to a messaging component associated with the user for display on one or more client devices associated with the user;
in response to transmitting the first push notification to the network service and receiving an indication of the one or more client devices accessing the self-registration application, requesting a response including at least identification information and benefits provider information, wherein identification information comprises information associated with a photo identification card;
receiving the response comprising received identification information and received benefits provider information;
converting the received identification information to a standardized identification information using a second standardized format associated with identity information, the second standardized format for use with identification information of different users and convert the received benefits provider information to a standardized benefits provider information using a third standardized format associated with benefits provider information, the third standardized format for use with benefits provider information of different benefits providers;
conducting an identity verification check using the standardized identification information to determine whether the standardized identification information is valid;
conducting a security check by requesting answers to one or more security questions, the one or more security questions based on one or more of: demographic information, answers to questions previously provided by the user, credit profile data, or public information;
after receiving one or more answers to the one or more security questions, verifying the one or more answers by comparing the one or more answers to known information to determine if the one or more answers are valid;
conducting a benefits provider verification check using the standardized benefits provider information to determine whether the standardized benefits provider information is valid;
after determining that the standardized identification information is valid, determining that the standardized benefits provider information is valid, and determining that the one or more answers are valid, automatically transmitting to the one or more client devices, via the self-registration application associated with the user, a request for confirmation of the service appointment, wherein receipt of the confirmation completes the self-registration process; and
in response to receiving the confirmation, providing a notification to the service provider system to indicate the self-registration process is completed.

36. The method of claim 35, further comprising:
in response to determining the user does not qualify for self-registration, flagging the self-registration process as incomplete and notifying the service provider system.

37. The method of claim 35, further comprising:
providing the user an option to opt out of the self-registration process; and
if the user selects the option to opt out of the self-registration process, flagging the self-registration process as incomplete and notifying the service provider system.

38. At least one non-transitory storage media storing instructions that, when executed by at least one processor, cause the at least one processor to:
receive, via an interface portal, a scheduling event from a service provider system of a plurality of service provider systems, the scheduling event associated with a service appointment for a user;
convert the scheduling event to a standardized scheduling event using a first standardized format associated with service provider events and for use with the plurality of service provider systems, the standardized scheduling event including service provider information;
extract a service provider identifier from the scheduling event;
access a set of self-registration rules associated with the service provider identifier, wherein the set of self-registration rules are generated based on at least one of procedure type or patient characteristic;
apply one or more rules of the set of self-registration rules to determine the user qualifies for self-registration;
automatically generate a first push notification comprising:
an electronic notification message informing the user of a self-registration process for the service appointment, and a first embedded access link to a self-registration application associated with the system for initiation of the self-registration process;
automatically send the first push notification to a network service for transmission to a messaging component associated with the user for display on one or more client devices associated with the user;
in response to transmitting the first push notification to the network service and receiving an indication of the one or more client devices accessing the self-registration application, request a response including at least identification information and benefits provider information;
receive the response comprising received identification information and received benefits provider information;
convert the received identification information to a standardized identification information using a second standardized format associated with identity information, the second standardized format for use with identification information of different users and convert the received benefits provider information to a standardized benefits provider information using a third standardized format associated with benefits provider information, the third standardized format for use with benefits provider information of different benefits providers;
conduct an identity verification check using the standardized identification information to determine whether the standardized identification information is valid;
conduct a security check by requesting answers to one or more security questions, the one or more security questions based on one or more of: demographic information, answers to questions previously provided by the user, credit profile data, or public information;
after receiving one or more answers to the one or more security questions, verify the one or more answers by comparing the one or more answers to known information to determine if the one or more answers are valid;
conduct a benefits provider verification check using the standardized benefits provider information to determine whether the standardized benefits provider information is valid;
after determining that the standardized identification information is valid, determining that the standardized benefits provider information is valid, and determining that the one or more answers are valid, automatically transmit to the one or more client devices, via the self-registration application associated with the user, a request for confirmation of the service appointment, wherein receipt of the confirmation completes the self-registration process; and
in response to receiving the confirmation, provide a notification to the service provider system to indicate the self-registration process is completed.

39. The non-transitory storage media of claim 38, wherein the instructions, when executed, further cause the at least one processor to:
in response to determining the user does not qualify for self-registration, flag the self-registration process as incomplete and notify the service provider system.

40. The non-transitory storage media of claim 38, wherein the instructions, when executed, further cause the at least one processor to:
provide the user an option to opt out of the self-registration process; and
if the user selects the option to opt out of the self-registration process, flag the self-registration process as incomplete and notify the service provider system.
